(19) United States
(12) Patent Application Publication
(10) Pub. No.: US 2025/0079898 A1
(43) Pub. Date: Mar. 6, 2025

(54) NEAR FIELD COMMUNICATION TAG WITH ON/OFF CAPABILITY

(71) Applicant: AIRA, INC., Phoenix, AZ (US)

(72) Inventors: Jake Slatnick, San Diego, CA (US); Frank Schwab, Phoenix, AZ (US)

(21) Appl. No.: 18/822,071

(22) Filed: Aug. 30, 2024

Related U.S. Application Data
(60) Provisional application No. 63/536,072, filed on Aug. 31, 2023.

(51) Int. Cl. H02J 50/12; H02J 50/80; H04B 5/79; H04B 10/80

(52) U.S. Cl. CPC H02J 50/12; H02J 50/80; H04B 5/79; H04B 10/807

(57) ABSTRACT

A wireless tag has an antenna configured to receive a wireless signal when enabled, a transceiver coupled to the antenna and configured to process the wireless signal, a controller configured to respond to the wireless signal by transmitting a response signal through the transceiver and antenna when the antenna is enabled, and a switching circuit configured to enable and disable the antenna responsive to a control signal. The antenna may be disabled when the control signal is in a first signaling state and enabled when the control signal is in a second signaling state. An optical receiver may be configured to define signaling state of the control signal based on detection or non-detection of light transmission initiated by an external processing circuit or controller. An energy capture circuit may be configured to extract energy from the wireless signal and to store the energy for use when transmitting the response signal.

### PRIORITY CLAIM

This application claims priority to and the benefit of provisional patent application No. 63/536,072 filed in the United States Patent Office on Aug. 31, 2023, the entire content of this application being incorporated herein by reference as if fully set forth below in its entirety and for all applicable purposes.

### TECHNICAL FIELD

The present invention relates generally to charging surfaces for wireless charging of batteries, including batteries in mobile computing devices and more particularly to providing a charging surface in a countertop or other surface.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Improvements in wireless charging capabilities are required to provide flexibility in charging configurations and support continually increasing complexity of mobile devices and changing form factors.

### BRIEF DESCRIPTION OF THE DRAWINGS

FIG. 1 illustrates an example of a charging cell that may be employed to provide a charging surface in accordance with certain aspects disclosed herein.

FIG. 2 illustrates an example of an arrangement of charging cells provided on a single layer of a segment of a charging surface that may be adapted in accordance with certain aspects disclosed herein.

FIG. 3 illustrates the arrangement of power transfer areas provided by a charging surface that employs multiple layers of charging cells configured in accordance with certain aspects disclosed herein.

FIG. 4 illustrates a wireless transmitter that may be provided in a charger base station in accordance with certain aspects disclosed herein.

FIG. 5 illustrates a first topology that supports matrix multiplexed switching for use in a wireless charging device adapted in accordance with certain aspects disclosed herein.

FIG. 6 illustrates a second topology that supports direct current drive in a wireless charging device adapted in accordance with certain aspects disclosed herein.

FIG. 7 illustrates an example of a modular charging surface provided in accordance with certain aspects disclosed herein.

FIG. 8 illustrates an example of a Litz transmitting coil configured in accordance with certain aspects of this disclosure.

FIG. 9 illustrates an example of a portion of a charging surface provided using multiple overlapping Litz coils in accordance with certain aspects of this disclosure.

FIG. 10 illustrates a charging assembly in a wireless charging device constructed from Litz coils according to certain aspects of this disclosure.

FIG. 11 illustrates certain aspects of a Litz coil substrate provided in accordance with certain aspects of this disclosure.

FIG. 12 illustrates an example of a charging system that includes multiple charging devices provided in accordance with certain aspects of this disclosure.

FIG. 13 illustrates a first example of a combined control circuit in a modular charging surface provided in accordance with certain aspects disclosed herein.

FIG. 14 illustrates a second example of a combined control circuit that may be provided in a modular charging surface provided according to certain aspects disclosed herein.

FIG. 15 illustrates the use of modular charging devices to provide one or more charging surfaces on an item of furniture in accordance with certain aspects of this disclosure.

FIG. 16 illustrates a configuration of charging areas on a surface configured in accordance with certain aspects of this disclosure.

FIG. 17 illustrates an example of a wireless tag that may be adapted in accordance with certain aspects of this disclosure.

FIG. 18 illustrates an example of a system that includes a wireless charging circuit and one or more NFC tags.

FIG. 19 illustrates an example of a wireless tag that can be repetitively enabled and disabled in accordance with certain aspects of this disclosure.

FIG. 20 illustrates certain examples of switching circuits that may be used to implement the switching circuit illustrated in FIG. 19.

FIG. 21 illustrates an example of a switching circuit that is activated through an optical path in accordance with certain aspects disclosed herein.

FIG. 22 is flowchart illustrating an example of a method for operating a charging system in accordance with certain aspects disclosed herein.

FIG. 23 illustrates one example of an apparatus employing a processing circuit that may be adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communications (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

Certain aspects of the present disclosure relate to systems, apparatus and methods associated with wireless charging devices that provide a free-positioning charging surface using multiple transmitting coils or that can concurrently charge multiple receiving devices. In one aspect, a controller in the wireless charging device can locate a device to be charged and can configure one or more transmitting coils optimally positioned to deliver power to the receiving device. Charging cells may be provisioned or configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

Certain aspects disclosed herein relate to improved wireless charging systems. Systems, apparatus and methods are disclosed that accommodate free placement of chargeable devices on one or more surfaces provided by a charging system constructed from modular surface elements. In one example, a single surface provided by the charging system is formed from a configuration of multiple modular multi-coil wireless charging elements. In another example, a distributed charging surface may be provided by the charging system using multiple interconnected multi-coil wireless charging elements.

Certain aspects can improve the efficiency and capacity of a wireless power transmission to a receiving device. In one example, a wireless charging device has a battery charging power source, a plurality of charging cells configured in a matrix, a first plurality of switches in which each switch is configured to couple a row of coils in the matrix to a first terminal of the battery charging power source, and a second plurality of switches in which each switch is configured to couple a column of coils in the matrix to a second terminal of the battery charging power source. Each charging cell in the plurality of charging cells may include one or more coils surrounding a power transfer area. The plurality of charging cells may be arranged adjacent to a charging surface without overlap of power transfer areas of the charging cells in the plurality of charging cells.

Certain aspects of the present disclosure relate to systems, apparatus and methods for a wireless charging system that provide multiple power transmitting coils in elements of a modular or distributed surface. The coils may be stacked and can be used to charge target devices presented to the wireless charging systems without a requirement to match a particular geometry or location within a charging surface of the charging device. Each coil may have a shape that is substantially polygonal. In one example, each coil may have a hexagonal shape. Each coil may be implemented using wires, printed circuit board traces and/or other connectors that are provided in a spiral. In one example, the coils coil may be implemented using Litz wires. Each coil may span two or more layers separated by an insulator or substrate such that coils in different layers are centered around a common axis.

According to certain aspects disclosed herein, devices placed on a charging surface provided by the wireless charging system may receive power that is wirelessly transmitted through one or more of the charging cells that are associated with the charging surface. Power can be wirelessly transferred to a receiving device located anywhere on the charging surface. The receiving device can have an arbitrarily defined size and/or shape and may be placed without regard to any discrete placement locations enabled for charging. Multiple devices can be simultaneously or concurrently charged on a single surface. The apparatus can track motion of one or more devices across the surface. A charging system may provide multiple charging surface portions that are physically separated from one another but managed as a single modular charging surface that can manage and control simultaneously charging of multiple devices. The charging system may be manufactured at low cost and/or with a compact design.

Certain aspects of the present disclosure relate to systems, apparatus and methods applicable to wireless charging devices that provide a free-positioning charging surface that has multiple transmitting coils or that can concurrently charge multiple receiving devices. In one aspect, a processing circuit coupled to the free-positioning charging surface can be configured to locate a device to be charged and can select and configure one or more power transmitting coils that are optimally positioned to deliver power to the receiving device. Charging cells may be configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

According to certain aspects disclosed herein, a charging surface in a wireless charging device may be provided using charging cells that are deployed adjacent to a surface of the charging device. In one example the charging cells are deployed in accordance with a honeycomb packaging configuration. A charging cell may be implemented using one or more coils that can each induce a magnetic field along an axis that is substantially orthogonal to the charging surface. In this disclosure, a charging cell may refer to an element having one or more coils where each coil is configured to produce an electromagnetic field that is additive with respect to the fields produced by other coils in the charging cell and directed along or proximate to a common axis. In this description, a coil in a charging cell may be referred to as a charging coil or a transmitting coil.

In some examples, a charging cell includes coils that are stacked along a common axis. One or more coils may overlap such that they contribute to an induced magnetic field substantially orthogonal to the charging surface. In some examples, a charging cell includes coils that are arranged within a defined portion of the charging surface and that contribute to an induced magnetic field within the defined portion of the charging surface, the magnetic field contributing to a magnetic flux flowing substantially orthogonal to the charging surface. In some implementations, charging cells may be configurable by providing an activating current to coils that are included in a dynamically-defined charging cell. For example, a wireless charging device may include multiple stacks of coils deployed across a charging surface, and the wireless charging device may detect the location of a device to be charged and may select some combination of stacks of coils to provide a charging cell adjacent to the device to be charged. In some instances, a charging cell may include, or be characterized as a single coil. However, it should be appreciated that a charging cell may include multiple stacked coils and/or multiple adjacent coils or stacks of coils.

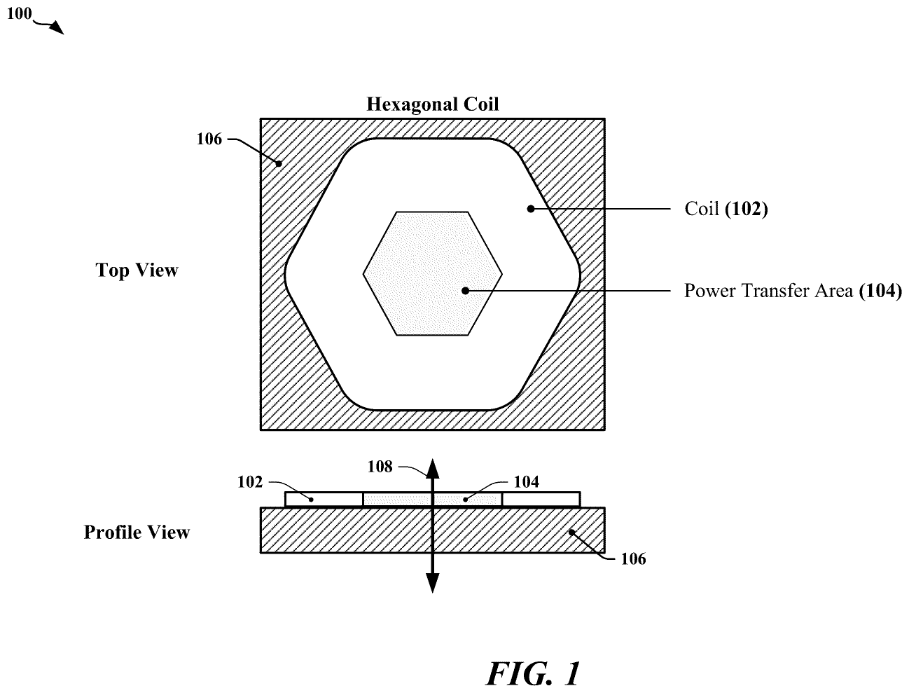

FIG. 1 illustrates an example of a charging cell 100 that may be deployed and/or configured to provide a charging surface in a wireless charging device. In this example, the charging cell 100 has a substantially hexagonal shape that encloses one or more coils 102 constructed using conductors, wires or circuit board traces that can receive a current sufficient to produce an electromagnetic field in a power transfer area 104. In various implementations, some coils 102 may have a shape that is substantially polygonal, including the hexagonal charging cell 100 illustrated in FIG. 1. Other implementations may include or use coils 102 that have other shapes. The shape of the coils 102 may be determined at least in part by the capabilities or limitations of fabrication technology or to optimize layout of the charging cells on a substrate 106 such as a printed circuit board substrate. Each coil 102 may be implemented using wires, printed circuit board traces and/or other connectors in a spiral configuration. The wires may comprise Litz wires. Each charging cell 100 may span two or more layers separated by an insulator or substrate 106 such that coils 102 in different layers are centered around a common axis 108.

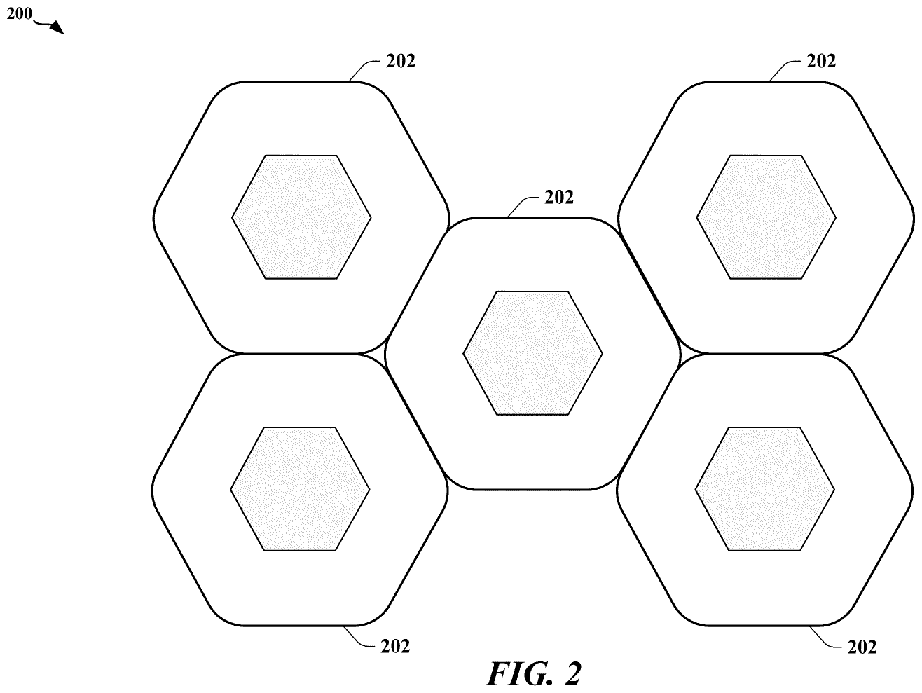

FIG. 2 illustrates an example of an arrangement 200 of charging cells 202 provided on a single layer of a segment or portion of a charging surface that may be adapted in accordance with certain aspects disclosed herein. The charging cells 202 are arranged according to a honeycomb packaging configuration. In this example, the charging cells 202 are arranged end-to-end without overlap. This arrangement can be provided without through-holes or wire interconnects. Other arrangements are possible, including arrangements in which some portion of the charging cells 202 overlap. For example, wires of two or more coils may be interleaved to some extent.

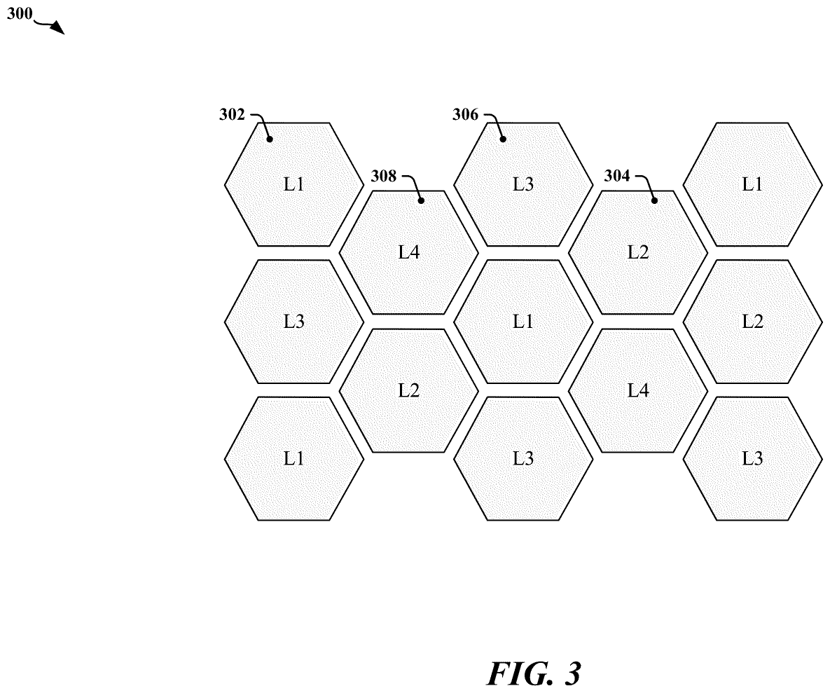

FIG. 3 illustrates the arrangement of power transfer areas provided across a charging surface 300 of a charging device that employs multiple layers of charging cells configured in accordance with certain aspects disclosed herein. The charging device may be constructed from four layers of charging cells 302, 304, 306, 308. In FIG. 3, each power transfer area provided by a charging cell in the first layer of charging cells 302 is marked “L1”, each power transfer area provided by a charging cell in the second layer of charging cells 304 is marked “L2”, each power transfer area provided by a charging cell in the third layer of charging cells 306 is marked “L3”, and each power transfer area provided by a charging cell in the fourth layer of charging cells 308 is marked “L4”.

In accordance with certain aspects disclosed herein, location sensing may rely on changes in some property of the electrical conductors that form coils in a charging cell. Measurable differences in properties of the electrical conductors may include capacitance, resistance, inductance and/or temperature. In some examples, loading of the charging surface can affect the measurable resistance of a coil located near the point of loading. In some implementations, sensors may be provided to enable location sensing through detection of changes in touch, pressure, load and/or strain. Certain aspects disclosed herein provide apparatus and methods that can sense the location of devices that may be freely placed on a charging surface using low-power differential capacitive sense techniques.

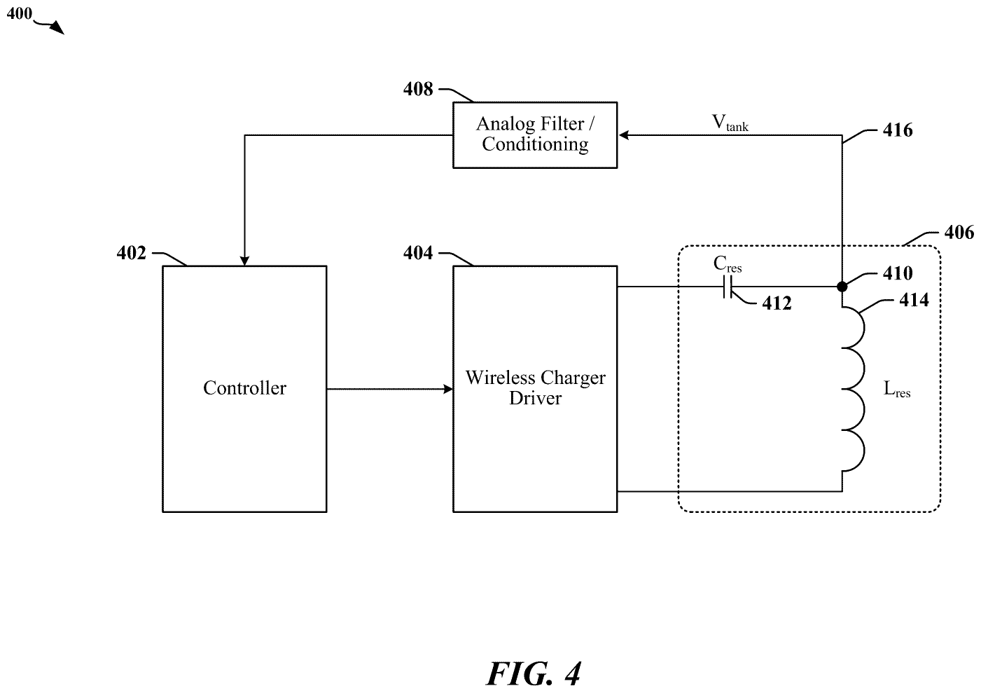

FIG. 4 illustrates an example of a wireless transmitter 400 that can be provided in a base station of a wireless charging device. A base station in a wireless charging device may include one or more processing circuits used to control operations of the wireless charging device. A controller 402 may receive a feedback signal filtered or otherwise processed by a filter circuit 408. The controller may control the operation of a driver circuit 404 that provides an alternating current to a resonant circuit 406. In some examples, the controller 402 may generate a digital frequency reference signal used to control the frequency of the alternating current output by the driver circuit 404. In some instances, the digital frequency reference signal may be generated using a programmable counter or the like. In some examples, the driver circuit 404 includes a power inverter circuit and one or more power amplifiers that cooperate to generate the alternating current from a direct current source or input. In some examples, the digital frequency reference signal may be generated by the driver circuit 404 or by another circuit. The resonant circuit 406 includes a capacitor 412 and inductor 414. The inductor 414 may represent or include one or more transmitting coils in a charging cell that produced a magnetic flux responsive to the alternating current. The resonant circuit 406 may also be referred to herein as a tank circuit, LC tank circuit, or LC tank, and the voltage 416 measured at an LC node 410 of the resonant circuit 406 may be referred to as the tank voltage.

Passive ping techniques may use the voltage and/or current measured or observed at the LC node 410 to identify the presence of a receiving coil in proximity to the charging pad of a device adapted in accordance with certain aspects disclosed herein. Some conventional wireless charging devices include circuits that measure voltage at the LC node 410 of the resonant circuit 406 or the current in the resonant circuit 406. These voltages and currents may be monitored for power regulation purposes and/or to support communication between devices. According to certain aspects of this disclosure, voltage at the LC node 410 in the wireless transmitter 400 illustrated in FIG. 4 may be monitored to support passive ping techniques that can detect presence of a chargeable device or other object based on response of the resonant circuit 406 to a short burst of energy (the ping) transmitted through the resonant circuit 406.

A passive ping discovery technique may be used to provide fast, low-power discovery. A passive ping may be produced by driving a network that includes the resonant circuit 406 with a fast pulse that includes a small amount of energy. The fast pulse excites the resonant circuit 406 and causes the network to oscillate at its natural resonant frequency until the injected energy decays and is dissipated. The response of a resonant circuit 406 to a fast pulse may be determined in part by the resonant frequency of the resonant LC circuit. A response of the resonant circuit 406 to a passive ping that has initial voltage=V₀ may be represented by the voltage V_{LC} observed at the LC node 410, such that:

$${V}_{L C} = {V}_{0} {e}^{- ( \frac{ω}{2 Q} ) t} \qquad ( Eq . 1 )$$

The resonant circuit 406 may be monitored when the controller 402 or another processor is using digital pings to detect presence of objects. A digital ping is produced by driving the resonant circuit 406 for a period of time. The resonant circuit 406 is a tuned network that includes a transmitting coil of the wireless charging device. A receiving device may modulate the voltage or current observed in the resonant circuit 406 by modifying the impedance presented by its power receiving circuit in accordance with signaling state of a modulating signal. The controller 402 or other processor then waits for a data modulated response that indicates that a receiving device is nearby.

According to certain aspects disclosed herein, power transmitting coils in one or more charging cells may be selectively activated to provide an optimal electromagnetic field for charging a compatible device. In some instances, power transmitting coils may be assigned to charging cells, and some charging cells may overlap other charging cells. The optimal charging configuration may be selected at the charging cell level. In some examples, a charging configuration may include charging cells in a charging surface that are determined to be aligned with or located close to the device to be charged. A controller may activate a single power transmitting coil or a combination of power transmitting coils based on the charging configuration which in turn is based on detection of location of the device to be charged. In some implementations, a wireless charging device may have a driver circuit that can selectively activate one or more power transmitting coils or one or more predefined charging cells during a charging event.

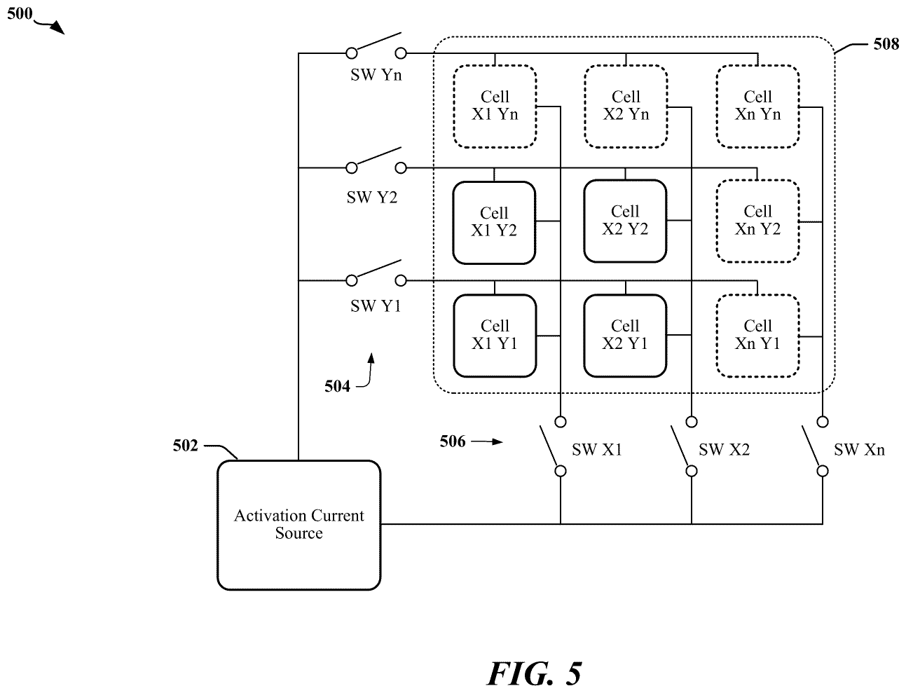

FIG. 5 illustrates a first topology 500 that supports matrix multiplexed switching for use in a wireless charging device adapted in accordance with certain aspects disclosed herein. The wireless charging device may select one or more charging cells 100 to charge a receiving device. Charging cells 100 that are not in use can be disconnected from current flow. A relatively large number of charging cells 100 may be used in the honeycomb packaging configuration illustrated in FIG. 2, requiring a corresponding number of switches. According to certain aspects disclosed herein, the charging cells 100 may be logically arranged in a matrix 508 having multiple cells connected to two or more switches that enable specific cells to be powered. In the illustrated topology 500, a two-dimensional matrix 508 is provided, where the dimensions may be represented by X and Y coordinates. Each of a first set of switches 506 is configured to selectively couple a first terminal of each cell in a column of cells to a first terminal of a voltage or current source 502 that provides current to activate coils in one or more charging cells during wireless charging. Each of a second set of switches 504 is configured to selectively couple a second terminal of each cell in a row of cells to a second terminal of the voltage or current source 502. A charging cell is active when both terminals of the cell are coupled to the voltage or current source 502.

The use of a matrix 508 can significantly reduce the number of switching components needed to operate a network of tuned LC circuits. For example, N individually connected cells require at least N switches, whereas a two-dimensional matrix 508 having N cells can be operated with \sqrt{N} switches. The use of a matrix 508 can produce significant cost savings and reduce circuit and/or layout complexity. In one example, a 9-cell implementation can be implemented in a 3×3 matrix 508 using 6 switches, saving 3 switches. In another example, a 16-cell implementation can be implemented in a 4×4 matrix 508 using 8 switches, saving 8 switches.

During operation, at least 2 switches are closed to actively couple one coil or charging cell to the voltage or current source 502. Multiple switches can be closed at once in order to facilitate connection of multiple coils or charging cells to the voltage or current source 502. Multiple switches may be closed, for example, to enable modes of operation that drive multiple transmitting coils when transferring power to a receiving device.

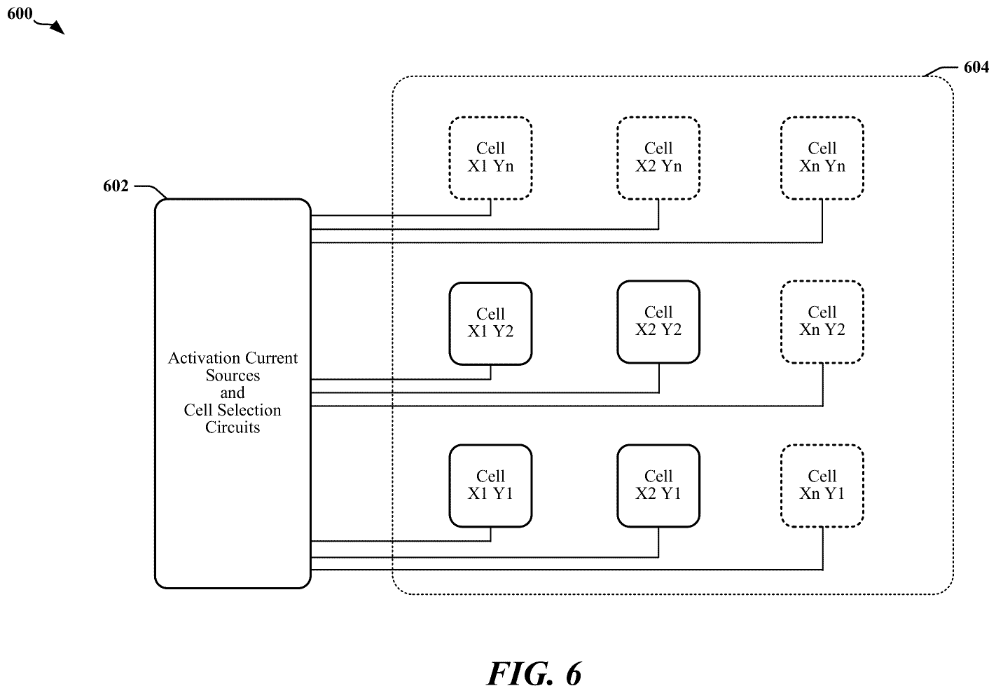

FIG. 6 illustrates a second topology 600 in which each individual coil or charging cell is directly driven by a driver circuit 602 in accordance with certain aspects disclosed herein. The driver circuit 602 may be configured to select one or more coils or charging cells 100 from a group of coils 604 to charge a receiving device. It will be appreciated that the concepts disclosed here in relation to charging cells 100 may be applied to selective activation of individual coils or stacks of coils. Charging cells 100 that are not in use receive no current flow. A relatively large number of charging cells 100 may be in use and a switching matrix may be employed to drive individual coils or groups of coils. In one example, a first switching matrix may configure connections that define a charging cell or group of coils to be used during a charging event and a second switching matrix may be used to activate the charging cell and/or group of selected coils.

According to certain aspects of this disclosure, a charging surface may be provided using wireless charging modules that include one or more charging coils arranged in substantially parallel alignment adjacent or proximate to the charging surface. According to one aspect, a charging system may include charging modules configured to provide a large surface area on which a chargeable device can be placed for charging and which can be controlled, managed or drive by one or more controlling subsystems. In some implementations, the charging modules may be physically coupled, joined or otherwise provided in a side-by-side or end-on-end configuration to provide a combined charging surface with a desired length, breadth or surface area. In some implementations, two or more of the charging modules may be physically separated and may provide multiple charging surfaces within a room or cabin of a vehicle or in different locations of an item of furniture, such as a desk, table, workbench, countertop including bar and kitchen worksurfaces, or the like. The charging system may include charging modules that have the same charging coil configuration, including same size and layout of charging coils. In some examples, the charging system includes different types of charging modules, including charging modules with different layouts, differently sized charging coils and/or different size. In some examples, a charging module may include charging coils of different sizes. In some examples, a charging module may include charging coils of different shapes. In some examples, a charging module may be constructed using a flexible printed circuit board (PCB) while other modular charging modules may be manufactured using inflexible materials.

According to certain aspects of this disclosure, a charging module provided in wireless charging system may be implemented using charging cells that include at least one Litz coil. A Litz coil may be constructed using a Litz wire to form a planar or substantially flat winding. The Litz coil may be configured with a central power transfer area that produces an electromagnetic flux when a charging current is passed through the Litz wire. Each charging cell may include or be associated with multiple Litz coils arranged to have coaxial or overlapping power transfer areas. In some instances, the charging cells may be arranged parallel to and adjacent to the charging surface of the charging module without overlap of the charging cells. In some instances, the charging cells may be arranged in multiple parallel layers, extending from a first layer that is parallel with and adjacent to the charging surface of the charging module. In some instances, Litz coils in each layer may at least partially overlap Litz coils in other layers.

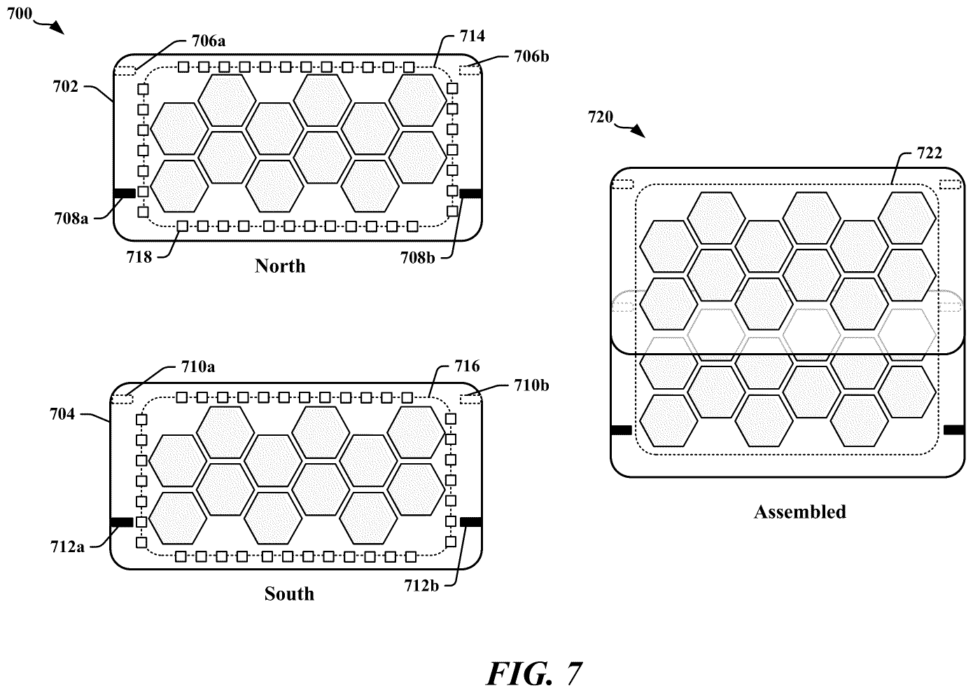

FIG. 7 illustrates an example in which a modular charging surface can be formed in accordance with certain aspects disclosed herein. The modular charging surface is constructed from two interconnected charging modules 702, 704. As illustrated in the pre-assembly view 700, the charging modules 702, 704 have a common size and shape, and a group of transmitting coils disposed across a charging surface provided by each charging module 702, 704. In this example, the charging modules 702, 704 are configured to be overlaid in either direction. In the illustrated example, the charging modules 702, 704 are configured to be overlaid in a North-South direction. Other configurations of the charging modules 702, 704 are contemplated. The charging modules 702, 704 may be overlaid to create a charging surface that is an integer N times the width of the area of a charging module 702, 704 that is delimited by an indicator line 714, 716. The illustrated assembled view 720 provides an example in which N=2, and where a North-side charging module 702 overlays a South-side charging module 704.

In certain implementations, light sources such as light emitting diode (LED) lamps or strips of LED lamps are provided to illuminate the indicator lines 714, 716 through a countertop, tabletop or other worktop. In certain implementations, the light sources may be electrically coupled to the charging module 702, as illustrated in the example by the LED lamp 718. In certain implementations, the light sources may be electrically coupled to the charging module 702, while being physically movable and/or manipulable without affecting the position of the charging module 702.

In some implementations, the indicator lines 714, 716 are defined by packaging specifications or designs and may not be physically inscribed, printed or otherwise marked on the surface of a countertop, tabletop or other worktop. In these implementations, the indicator lines 714, 716 are visible only when illuminating light is provided by at least one light source. In some implementations, the indicator lines 714, 716 may be physically marked on the countertop, tabletop or other worktop using silkscreen printing or other appropriate means, such that the indicator lines 714, 716 are visible even when the light sources are disabled. In one example, the light sources or associated light conducting materials may be visible even when no light is produced by the light sources. The indicator line 714, 716 may circumscribe the outline or outer limits of the transmitting coils.

In some implementations, light from the light sources may pass through the body of the countertop, tabletop or other worktop to illuminate the indicator lines 714, 716. In some implementations, the thickness of the countertop, tabletop or other worktop may be reduced proximate to the indicator lines 714, 716 in order to permit light from the light sources to propagate through the body of the countertop, tabletop or other worktop to illuminate the indicator lines 714, 716.

In some examples, light from the LED lamps is carried to an upper surface of the table, desk, workbench, bar top, kitchen worksurface, or other surface through light pipes, light guides and/or light diffusing materials or devices. A light pipe, for example, may be implemented LED light pipe using one or more optical fibers, a rod or shaft formed from a transparent polymer and the light pipe may be used to conduct light from an LED mounted on the charging module 702 to the upper surface of a countertop, desktop table, etc. In some implementations, light pipes, light guides or light diffusers may be used alone or in combination to provide a visible indicator line on the table, desk, workbench, bar top, kitchen worksurface, or other surface. In these latter implementations, the visible indicator line may be illuminated when a chargeable device is detected nearby. In some implementations, the charging module 702 or a controller may be configured with information that determines when the indicator line is illuminated. For example, the information may cause the indicator line to be illuminated permanently, for a defined duration, or for a period of time after occurrence of an event such as the detection of a chargeable device, presence of a user, or receipt of a command or other communication from a home automation system or from another controller. The information may cause the visible indicator line to be illuminated with a first color to indicate availability of charging circuits and with a second color to indicate that the charging surface is in use. In some instances, the color of the visible indicator line may indicate whether charging is in progress or completed, or whether an error has occurred. The error may relate to misalignment of the chargeable device, presence of a foreign object, an overheating condition or the like.

Light sources, including LED lamps, may be configured to emit light that is visible to a user before placement of a device on a charging surface, after placement of the device on the charging surface and/or while charging the device through the charging surface. In some instances, the light sources may be activated when presence of a person is detected in the vicinity of the table, desk, workbench, bar top, kitchen worksurface, or other surface that includes the charging surface. For example, a change in lighting, a communication from a home automation device or controller, detection of sound or receipt of a voice command may cause the light sources to be activated. In some implementations, the frequency or rate at which the wireless charging module searches for chargeable devices may be increased when the light sources are activated. In some implementations, the frequency at which the wireless charging module searches for chargeable devices may be increased when a person is detected in the vicinity of the table, desk, workbench, bar top, kitchen worksurface, or other surface that includes the charging surface.

In various examples and configurations described in this disclosure, a charging surface may be provided as a portion of the surface of a desk, table, workbench, countertop including bar and kitchen worksurfaces, or other item of furniture through which electromagnetic flux can be delivered by one or more power transmitting coils in a wireless charging module. Typically, the wireless charging module is located below the surface of the desk, table, workbench, countertop, bar worksurface, kitchen worksurface, or an item of furniture.

The transmitting coils of the charging modules 702, 704 may be arranged in a pattern that continues uninterrupted when the charging modules 702, 704 are overlaid. A combined indicator line 722 may be defined by the location of LED lamps, portions of strips of LED lamps or other light sources that are available for use during operation of the charging module. A processing circuit may manage operation of the LEDs or strips of LEDs. In one example, a controller of the processing circuit may detect the presence or absence of a chargeable device and may select some combination of LED lamps to be illuminated in order to provide a visual reference that assists a user to properly locate the charging surface. The controller may also configure colors for the LEDs to indicate state and progress of a charging transaction, error conditions and the like. In one example, the controller may configure a first color for the LEDs to indicate a charging area that is available for charging, a second color for the LEDs to indicate the charging area is being used for charging, and a third color for the LEDs to indicate that charging has been completed. In one example, the controller may configure a first sequence of color changes for the LEDs to indicate a charging area that is available for charging, a second sequence of color changes for the LEDs to indicate the charging area is being used for charging, and a third sequence of color changes for the LEDs to indicate that charging has been completed. Each sequence of color changes may the LEDs to emit a pattern of light. The controller may configure the intensity of light emitted by the LEDs to accommodate changes in ambient lighting.

In the illustrated example, each charging module 702, 704 has underside connector areas 706a, 706b, 710a, 710b and topside connector areas 708a, 708b, 712a, 712b that are positioned to overlap when the charging modules 702, 704 are overlaid. Mechanical fasteners may be located in the underside connector areas 706a, 706b, 710a, 710b and topside connector areas 708a, 708b, 712a, 712b. Mechanical fasteners may include bonding points, screws, or other devices that can fasten and/or hold the charging modules 702, 704 in place when overlaid. Electrical connectors may be located in the underside connector areas 706a, 706b, 710a, 710b and topside connector areas 708a, 708b, 712a, 712b. The electrical connectors may conduct data communication links and/or charging currents between the charging modules 702, 704 enabling a controller to configure and operate groups of transmitting coils when charging a receiving device placed on or near the charging surface.

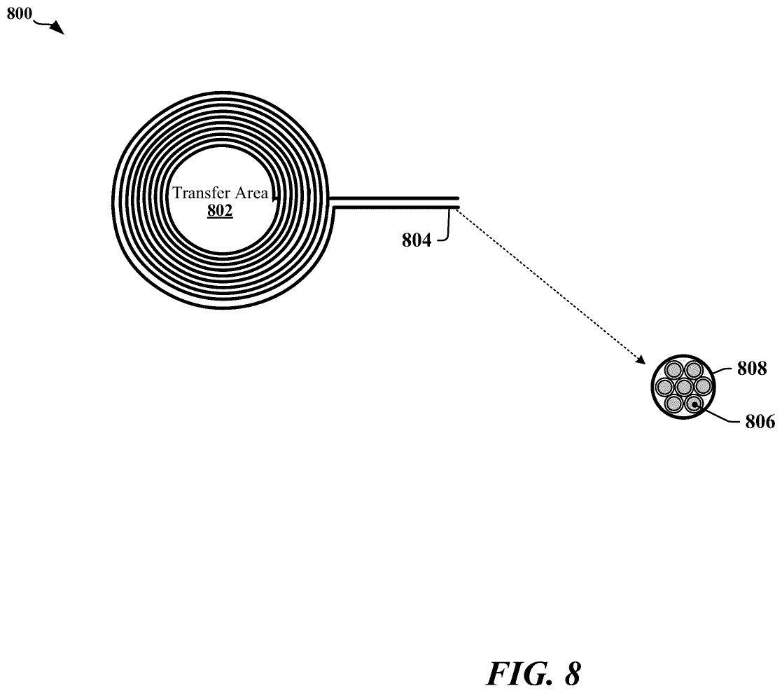

FIG. 8 illustrates an example of a transmitting coil configured in accordance with certain aspects of this disclosure. The transmitting coil may be wound from a multi-stranded Litz wire 804 and may be referred to as a Litz coil 800. Each strand 806 of the Litz wire 804 is formed as an insulated conductor that is sufficiently thin to mitigate or substantially reduce skin effect loss. Skin effect losses can occur in wires carrying high frequency signals. Current tends to flow at the outermost reaches (skin) of the wire, and the increased current density can increase localized heating and electrical resistance. The strands 806 of the Litz wire 804 are insulated to maintain their individual nature and are twisted such that the relative positioning of the individual strands 806 changes over the length of the Litz wire 804. In some instances, the strands 806 are bound by an exterior insulating layer 808. The Litz coil 800 can be wound as a substantially planar coil with an open interior that corresponds to a power transfer area 802.

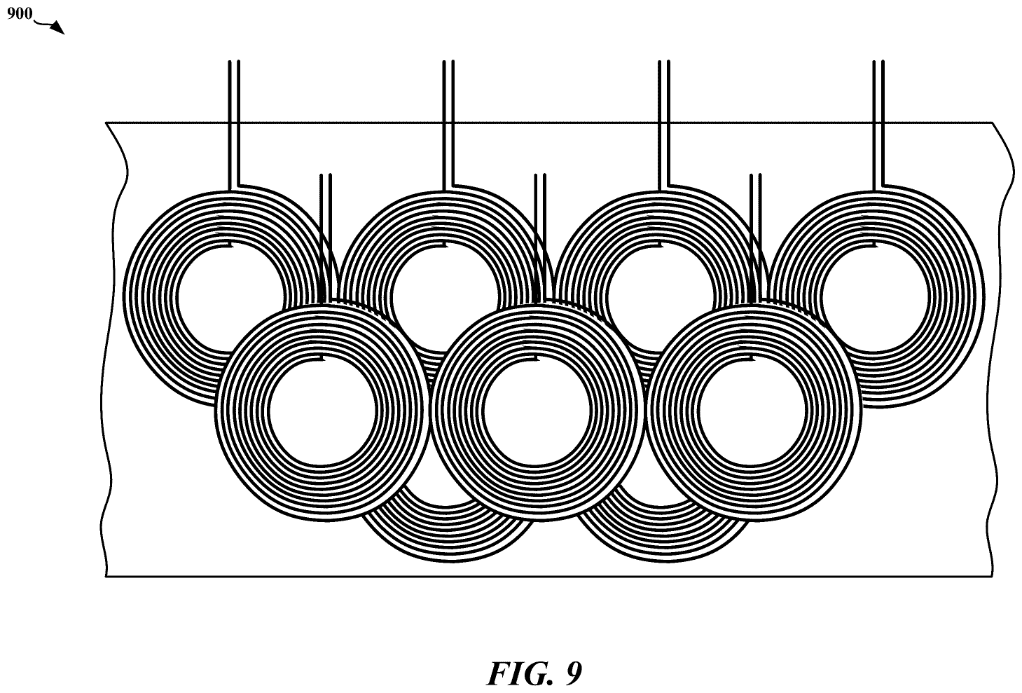

FIG. 9 illustrates an example of a portion of a charging surface 900 provided using multiple overlapping Litz coils 800. In the illustrated example, the charging surface 900 is constructed using three layers of Litz coils 800, although the number of layers of Litz coils 800 and arrangement of the Litz coils 800 in the charging surface 900 may vary according to application, size of the charging surface 900 and power transfer requirements per Litz coil 800.

The configuration of Litz coils 800 in a charging surface 900 may be precisely defined by design requirements. In some instances, it can be difficult to manage and align the number of Litz coils 800 to be assembled during manufacture of a wireless charging module that provides a free-positioning charging surface using multiple transmitting coils. Variability in positioning of the Litz coils 800 during manufacture can result in imprecise configurations of coils in some finished devices. In some instances, the Litz coils 800 may be retained in position using an adhesive or epoxy resin. According to certain aspects of this disclosure, a substrate may be configured to receive the Litz coils 800 and maintain the Litz coils 800 in a desired configuration for the lifetime of the wireless charging module.

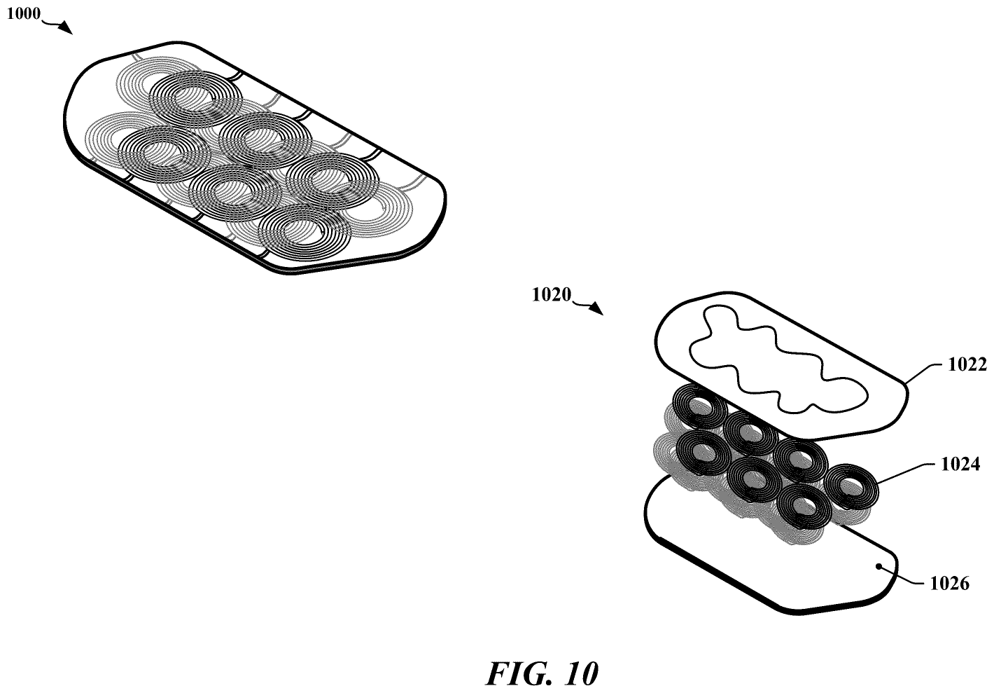

FIG. 10 illustrates a charging module 1000 in a wireless charging module constructed from Litz coils 800 according to certain aspects of this disclosure. The exploded view 1020 shows a Litz coil substrate 1022 configured to receive Litz coils and maintain the Litz coils in a predefined multi-layer Litz coil structure 1024 with 3D displacements between coils that meet tolerances defined by a designer. The Litz coil substrate 1022 may also define the spatial relationship between the multi-layer Litz coil structure 1024 and a ferrite layer 1026 or another type of magnetic half-core.

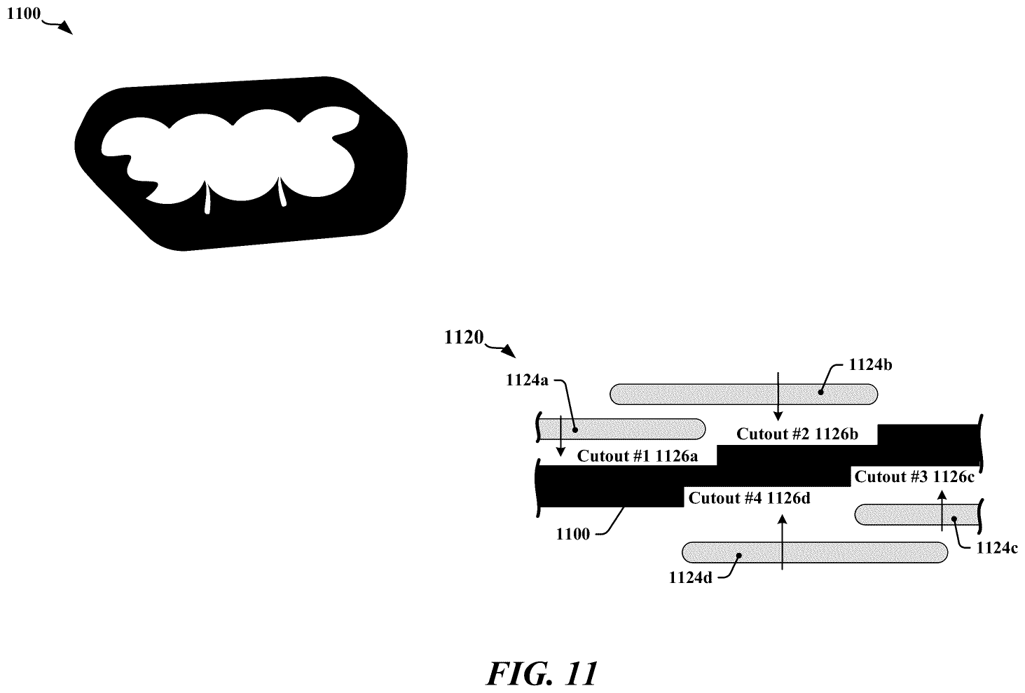

FIG. 11 illustrates certain aspects of a Litz coil substrate 1100 provided in accordance with certain aspects of this disclosure. The Litz coil substrate 1100 may be formed from a polymer, acetate, vinyl, nitrile rubber, latex, extruded polystyrene foam and/or other material. The Litz coil substrate 1100 may have multiple cutouts that enable Litz coils 800 to be placed in position in an ordered assembly. In some examples, the cut-outs may be preformed, including when the Litz coil substrate 1100 is manufactured by 3D printing, molding, extrusion and/or low-pressure expansion. In some examples, the cut-outs may be formed by milling, grinding, etching, abrading, chemical erosion, chemical dissolution or by another technique suitable for use with the material used to form the Litz coil substrate 1100.

Certain aspects of the Litz coil substrate 1100 are illustrated in a cross-sectional view 1120. The illustrated Litz coil substrate 1100 provides a four-layer charging surface and the cross-sectional view 1120 illustrates an example of placement and assembly of four Litz coils 1124a-1124d. The Litz coil substrate 1100 has a deep, first cutout 1126a in the Litz coil substrate 1100 that receives a first Litz coil 1124a. This first cutout 1126a may be formed as a complete circle in some examples. In other examples, the first cutout 1126a may have a portion that overlaps a portion of another cutout in the same plane of the Litz coil substrate 1100.

When the first Litz coil 1124a has been secured within the first cutout 1126a, a second Litz coil 1124b may be placed in a second cutout 1126b in the Litz coil substrate 1100. When in position within the Litz coil substrate 1100, the second Litz coil 1124b lies in a plane above the plane that includes the first Litz coil 1124a. A portion of the second Litz coil 1124b overlaps a portion of the first Litz coil 1124a. The separation of the planes that include the horizontal center lines of the first Litz coil 1124a and the second Litz coil 1124b may be configured by the relative difference in depths of the first cutout 1126a and the second cutout 1126b.

The third Litz coil 1124c is received by a deep, third cutout 1126c in the Litz coil substrate 1100. This third cutout 1126c may be formed as a complete circle in some examples. In other examples, the third cutout 1126c may overlap with another cutout in the same plane. In one example, the third cutout 1126c may partially overlap the first cutout 1126a resulting in a through-hole, when the bottom surface of the first Litz coil 1124a is in the same plane as the top surface or some other portion of the third Litz coil 1124c.

When the third Litz coil 1124c has been secured within the third cutout 1126c, a fourth Litz coil 1124d may be placed in a fourth cutout 1126d. The fourth Litz coil 1124d lies in a plane below the plane that includes the third Litz coil 1124c. A portion of the fourth Litz coil 1124d overlaps a portion of the third Litz coil 1124c when secured within the Litz coil substrate 1100. The separation of the planes that include the horizontal center lines of the third Litz coil 1124c and the fourth Litz coil 1124d may be configured by the relative difference in depths of the third cutout 1126c and the fourth cutout 1126d.

A Litz coil 1124a-1124d may be secured within the Litz coil substrate 1100 through a pressure fit, including when the Litz coil substrate 1100 is manufactured from a foam material. In some examples, a Litz coil 1124a-1124d may be secured within the Litz coil substrate 1100 by adhesive. In some examples, a Litz coil 1124a-1124d may be secured within the Litz coil substrate 1100 by mechanical means.

In some implementations, a completed charging assembly comprising the Litz coil substrate 1100 and the Litz coils 1124a-1124d may be attached to, or mounted on a substrate, which may be retained within a housing that can be mounted under a countertop, for example. In some implementations, the completed charging assembly comprising the Litz coil substrate 1100 and the Litz coils 1124a-1124d may be attached to, or mounted on a printed circuit board, which may be retained within a housing.

Certain aspects of this disclosure apply to systems that provide a distributed charging surface that may be implemented using two or more modular charging devices to provide physically distributed charging surface portions that can be operated as a single modular charging surface. From an electrical circuit perspective, the components of the distributed charging surface may be electrically coupled or interconnected in the same manner as that of components in a single charging surface implemented using multiple modular charging devices. From a data communication perspective, the components of the distributed charging surface may be logically communicatively coupled or interconnected in the same manner as the components of a single charging surface implemented using multiple modular charging devices. The physical and electrical characteristics of interconnects may differ between a distributed charging surface and a single charging surface implemented using multiple modular charging devices based on length and impedance of interconnects and other physical characteristics of the interconnects. For the purposes of this description the communication and power distribution architectures may be considered to be identical for a distributed charging surface and for a single charging surface implemented using multiple modular charging devices.

In one example, a primary or main controller may be provided to manage and control charging and/or device discovery procedures in a wireless charging system that includes multiple modular charging devices. In some examples, a controller provided in one of the modular charging devices may be configured to serve as the main controller. In some examples, the main controller may be attached to an edge of a charging surface or provided separately from the modular charging devices. In the latter examples, the separated main controller may enable thin charging surfaces to be attached to or embed in an object of furniture or a surface in a vehicle.

The modular charging devices may include control circuits that can be used to monitor, configure and manage charging operations through the respective charging surfaces provided by the modular charging devices. In some instances, the control circuits may include processing devices or switches that enable the control circuits in a first modular charging device to manage and control charging and/or device discovery in a second modular charging device, including where the second modular charging device is spaced apart or otherwise physically separated from the first modular charging device. The control circuits may control flow of charging currents through access to a power source or by directing the charging current to independent groupings of coils provided on multiple charging modules in interconnected charging devices. The control circuits may be configured to define physically independent charging zones that can be managed and operated as a single system. In one example, the independent charging zones may be provided on a surface of a tabletop, shelf, appliance, or other suitable carrier. In another example, the independent charging zones may be deployed in multiple locations within a confined space, such as within a cabin of a car or other vehicle or form of transportation.

A modular or physically-distributed charging surface may be configured to optimize concurrent wireless charging of devices that have a variety of sizes and shapes or that have different sized receiving coils. Concurrent wireless charging of devices may be optimized when a maximum number of devices can be charged simultaneously without compromising speed of charging devices associated with high power consumption. In one example, a wireless charging system may be expected to charge a tablet computer and multiple smaller devices such as a smartwatch or mobile telephone. Optimal charging of the tablet computer may necessitate the use of a large transmitting coil, while smaller transmitting coils may facilitate stacking of physically smaller devices or devices associated with low power consumption by providing a larger number of charging cells within an area of the charging surface.

In one aspect of the disclosure, a mixture of modular or physically-distributed charging surfaces can be connected or coupled to provide different charging zones with different charging cell sizes. In another aspect of the disclosure, certain modular or physically-distributed charging surfaces can include different charging zones with different charging cell sizes. In another aspect of the disclosure, a standalone charging surface can include different charging zones with different charging cell sizes.

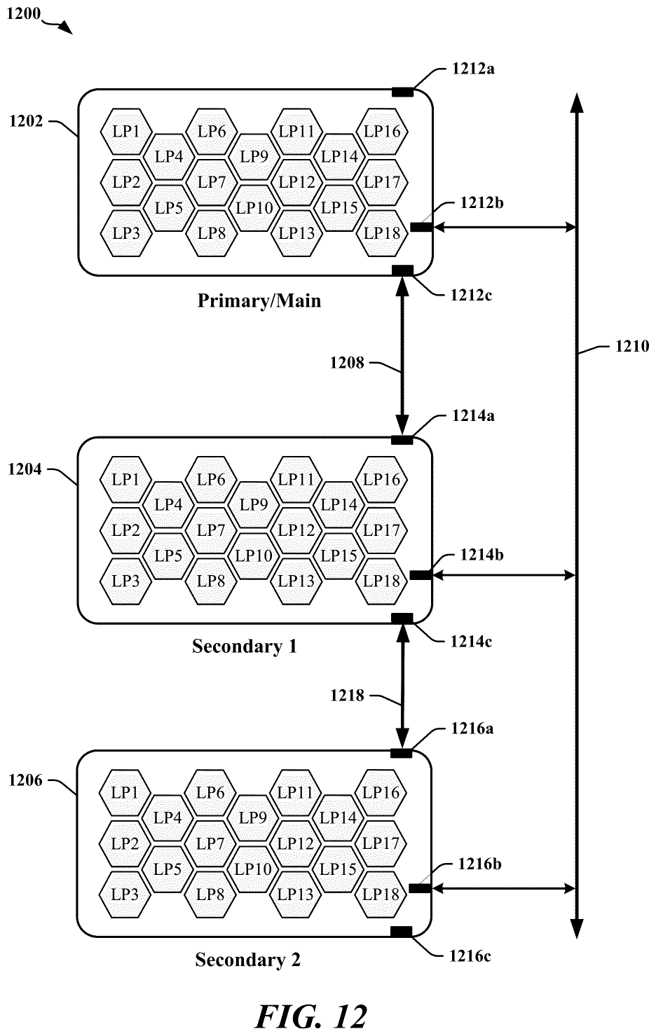

FIG. 12 illustrates an example of a charging system 1200 that includes multiple charging modules 1202, 1204, 1206 provided in accordance with certain aspects of this disclosure. In one example, the charging modules 1202, 1204, 1206 may be physically joined or interconnected to provide a single scalable, modular charging surface such as the modular charging surfaces illustrated in FIGS. 9-11. In some examples, one or more of the charging modules 1202, 1204, 1206 may be remotely located from at least one other charging module 1202, 1204, 1206 to provide a distributed charging surface. The charging system 1200 may include one or more controllers that can communicate with the charging modules 1202, 1204, 1206. In one example, a primary controller may communicate control messages to a secondary controller over a data communication link. In some examples, a primary controller may provide control signals that are used to control charging or detection operations at the charging modules 1202, 1204, 1206. In some examples, the primary controller may control power flow in the charging modules 1202, 1204, 1206. In some examples, the primary controller may provide charging currents to one or more groups of charging coils on the charging modules 1202, 1204, 1206.

Each charging module 1202, 1204, 1206 may include one or more charging cells that encompass one or more power transfer areas. Each power transfer area is substantially planar and centered around an axis that is substantially perpendicular to its a charging surface of its associated charging module 1202, 1204, 1206. In some examples, each of the charging modules 1202, 1204, 1206 can operate as a standalone wireless charger that includes controllers and power management circuits. The standalone wireless charger may be configured to detect chargeable devices, generate charging configurations and provide a charging current to one or more charging cells identified by the charging configurations.

In some examples, certain charging modules 1204, 1206 operate as secondary devices that have limited capability. In one example, the limited-capability charging modules 1204, 1206 receive charging currents through dedicated connectors and the charging currents are directed to one or more charging cells through fixed electrical paths or through a switch that may be controlled by a primary charging module 1204 or other centralized or distributed controller. In another example, the limited-capability charging modules 1204, 1206 may have a controller capable of selecting charging cells to receive a charging current and to provide the charging current to the selected charging cells. In the latter example, some limited-capability charging modules 1204, 1206 may be configured to exchange messages with one or more other charging modules 1202, 1204, 1206 in the system, or exchange messages with a chargeable device. In some instances, the limited-capability charging modules 1204, 1206 may be capable of conducting searches for chargeable devices or may be configured to participate in a search for chargeable devices controlled by a primary charging module 1204 or other centralized or distributed controller.

The charging system 1200 can be constructed from interconnected charging modules 1202, 1204, 1206. The charging modules 1202, 1204, 1206 may have a same or different size or shape. The charging modules 1202, 1204, 1206 may have a same or different number or configuration of power transmitting coils. In the illustrated example, the charging modules 1202, 1204, 1206 have similar size, shape and transmitting coil configuration, although the charging modules 1202, 1204, 1206 have a same or different configuration in other implementations. The charging modules 1202, 1204, 1206 may correspond to the charging modules illustrated in FIG. 7, 10 or 12 or may provide similar configurations of charging surfaces illustrated in the charging modules of FIG. 7, 10 or 12.

In certain examples, each of the charging modules 1202, 1204, 1206 includes one or more connectors 1212a, 1212b, 1212c, 1214a 1214b, 1214c, 1216a 1216b, 1216c, which may couple the charging modules 1202, 1204, 1206 to a multi-drop serial bus 1210 or support a daisy chain connection 1208, 1218. In one example, the multi-drop serial bus 1210 is configured as a serial bus that enables the charging modules 1202, 1204, 1206 to exchange command and control messages. In one example, the serial bus is operated in accordance with Improved Inter-Integrated Circuit (I3C) protocols, Controller Area Network (CAN) bus protocols, Local Interconnected Network (LIN) bus protocols, or the like. In some instances, the charging modules 1202, 1204, 1206 may communicate wirelessly. In some implementations, the daisy chain connection 1208, 1218 is used to distribute charging current among the charging modules 1202, 1204, 1206. The daisy chain connection 1208, 1218 may also be used for exchanging command and control messages.

In one example, one or more of the charging modules 1202, 1204, 1206 can serve as a primary device and may include a processing circuit configured to manage operation of one or more charging modules 1202, 1204, 1206 that is operated as a secondary device. In the illustrated example, two charging modules 1204, 1206 operate as secondary devices and may include processing circuits configured to communicate over the multi-drop serial bus 1210 in order to receive commands from the primary charging module 1202 and to report feedback information to the primary charging module 1202. Secondary charging modules 1202, 1204, 1206 may include or control a driver circuit that provides a flow of a charging current provided through the daisy chain connection 1208, 1218, when the charging current is provided by a current source through the operation of the primary charging module 1202.

The secondary charging modules 1204, 1206 may cooperate with the primary charging module 1202 to discover, enumerate and configure the combination of charging modules 1202, 1204, 1206 provided in the charging system 1200. In one example, the secondary charging modules 1204, 1206 participate in a serial bus arbitration process to identify themselves to the primary charging module 1202 and/or to obtain unique addresses. In another example, the secondary charging modules 1204, 1206 may be preconfigured with at least a secondary address that the primary charging module 1202 can use to address each secondary charging module 1204, 1206 through the multi-drop serial bus 1210. The primary charging module 1202 may use the multi-drop serial bus 1210 to configure the secondary charging modules 1204, 1206, interrogate the secondary charging modules 1204, 1206 for capability, charging cell size, number and configuration as well as status information. The primary charging module 1202 may use the multi-drop serial bus 1210 to configure the secondary charging modules 1204, 1206 for one or more charging operations.

In some implementations, each of the charging modules 1202, 1204, 1206 can be independently connected to a power supply that can be used to provide and configure a charging current. In one example, the charging modules 1202, 1204, 1206 may include an inverter or switching power supply configurable to produce an alternating current (AC) that has frequency suitable for wireless charging. In some implementations, each of the charging modules 1202, 1204, 1206 may be coupled to a multi-purpose communication bus that is used by other devices or systems (in an automobile for example). In the latter implementations, the primary charging module 1202 may also be a controlling entity on the bus.

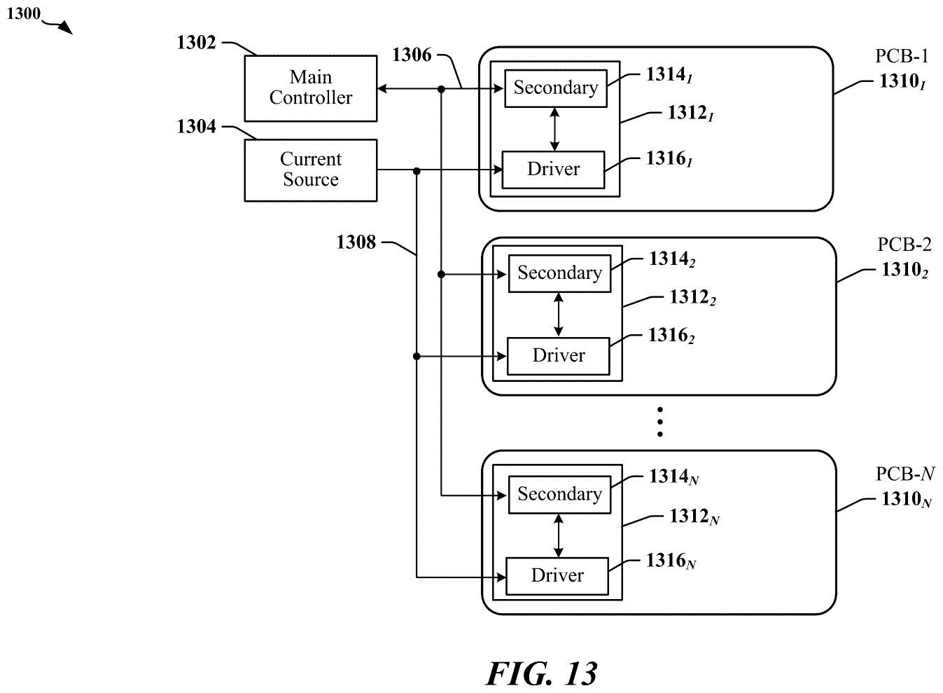

FIG. 13 illustrates a first example of a combined control circuit 1300 in a charging system provided in accordance with certain aspects disclosed herein. Each charging module 1310₁-1312_{N} includes a processing circuit 1312₁-1312_{N} that is configured and controlled by a main controller 1302 to manage operation of its respective charging module 1310₁-1312_{N}. In one example, each processing circuit 1312₁-1312_{N} includes a secondary circuit 1314₁-1314_{N} configured to communicate over a serial bus 1306 in order to receive commands and report feedback information to the main controller 1302. The secondary circuit 1314₁-1314_{N} may control a driver circuit 1316₁-1316_{N} that controls flow of a charging current provided through an interlink 1308 by a current source 1304.

The secondary circuits 1314₁-1314_{N} may cooperate with the main controller 1302 to discover, enumerate and configure the combination of charging modules 1310₁-1312_{N} provided in the modular charging surface. In one example, the secondary circuits 1314₁-1314_{N} participate in an arbitration process to identify themselves to the main controller 1302 and/or to obtain unique addresses. In another example, the secondary circuits 1314₁-1314_{N} may be preconfigured with at least a secondary address that the main controller 1302 can use to address each secondary circuit 1314₁-1314_{N} through the serial bus 1306. The main controller 1302 may use the serial bus 1306 to configure the secondary circuits 1314₁-1314_{N}, interrogate the secondary circuits 1314₁-1314_{N} for capability and status information, and configure the secondary circuits 1314₁-1314_{N} for one or more charging operations.

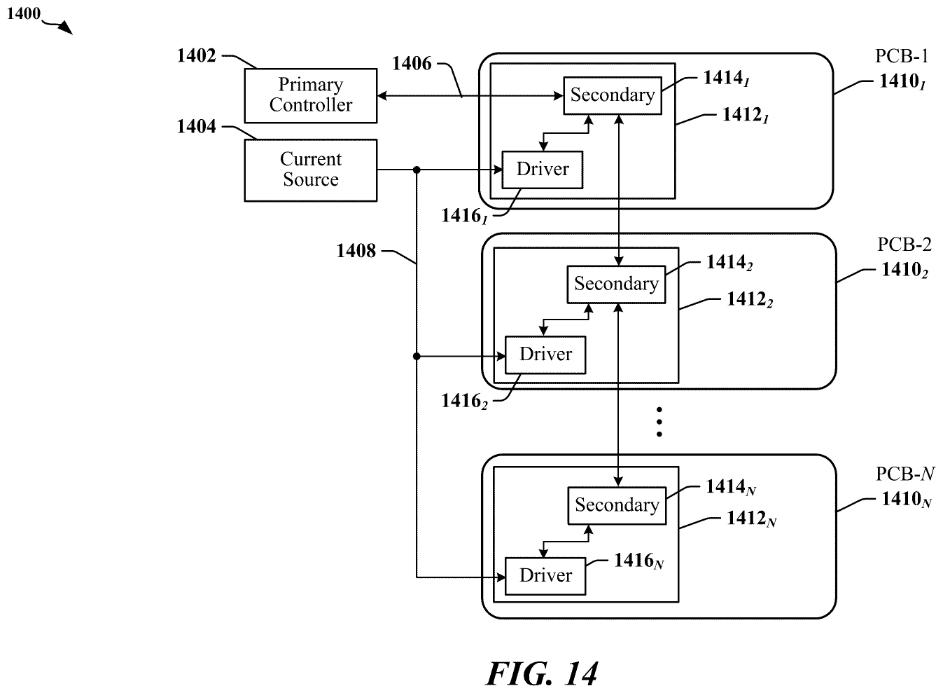

FIG. 14 illustrates a second example of a combined control circuit 1400 that may be provided in a charging system provided in accordance with certain aspects disclosed herein. Each charging module 1410₁-1412_{N} includes a processing circuit 1412₁-1412_{N} that is configured and controlled by a main controller 1402 to manage operation of its respective charging module 1410₁-1412_{N}. In one example, each processing circuit 1412₁-1412_{N} includes a secondary circuit 1414₁-1414_{N} configured to communicate over a serial bus 1406 in order to receive commands and report feedback information to the main controller 1402. The secondary circuit 1414₁-1414_{N} may control a driver circuit 1416₁-1416_{N} that controls flow of a charging current provided through an interlink 1408 by a current source.

The secondary circuits 1414₁-1414_{N} may cooperate with the main controller 1402 to discover, enumerate and configure the combination of charging modules 1410₁-1412_{N} provided in the modular charging surface. In the illustrated example, the secondary circuits 1414₁-1414_{N} are connected in a daisy chain fashion, whereby the main controller 1402 connects with and configures a first secondary circuit 1414₁, which then couples the second secondary circuit 1414₂ to the main controller 1402 through the serial bus 1406. The main controller 1402 configures the second secondary circuit 1414₂ and the process continues until the last secondary circuit 1414_{N} has been configured. In another example, the secondary circuits 1414₁-1414_{N} may be preconfigured with at least a secondary address that the main controller 1402 can use to address each secondary circuit 1414₁-1414_{N} through the serial bus 1406.

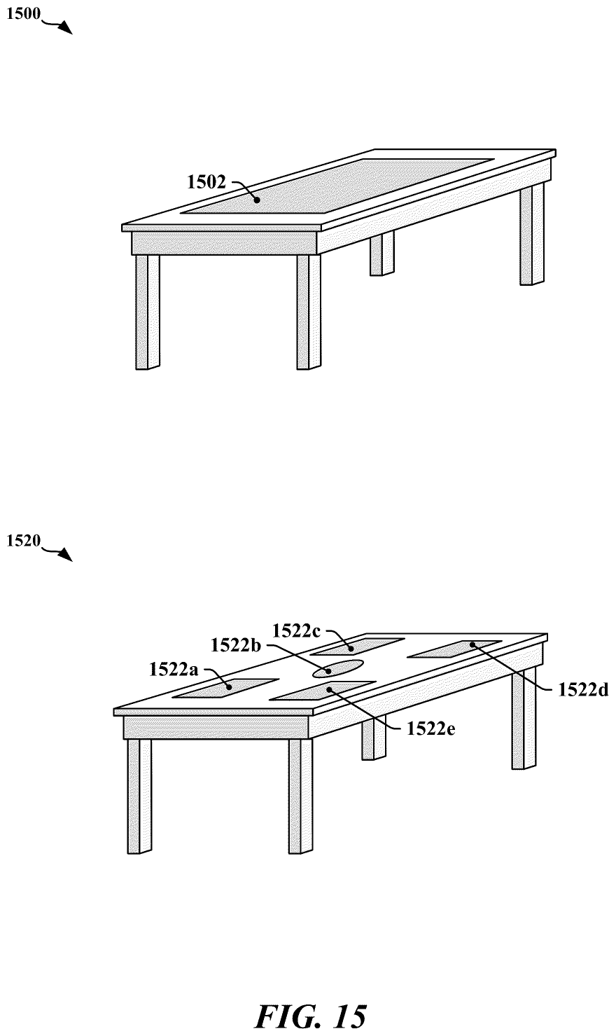

FIG. 15 illustrates an example use of charging devices to provide one or more charging areas on an item of furniture in accordance with certain aspects of this disclosure. In certain implementations, the charging surface is located on an upper surface of a countertop. The charging surface may correspond to a projection of the charging surface of a wireless charging device through the countertop. The charging surface can be expected to occupy an area that closely corresponds to the dimensions of the charging surface of the wireless charging device.

The illustrated charging devices may be provided in a desk, table 1500, 1520, workbench, countertop including bar and kitchen worksurfaces, or the like. The charging devices may be provided in other items including armrests of an armchair, armrests in an automobile, windowsills in a room, consoles in a vehicle, tray tables in an airplane and other examples. The example of a table 1500, 1520 is used in FIG. 15 for clarity and to facilitate description of certain aspects of a wireless charging system. A first table 1500 is equipped with a large charging surface 1502 that may be assembled from numerous charging modules that are arranged and configured to provide the large charging surface 1502. A second table 1520 is equipped with multiple charging surfaces 1522a-1522e that can have different sizes or shapes. Each of the charging surfaces 1522a-1522e may be implemented using one or more charging modules constructed in accordance with the examples illustrated herein. In some examples, at least one of the charging modules may differ from other charging modules in overall size or shape or by the number, size or configuration of included charging coils.

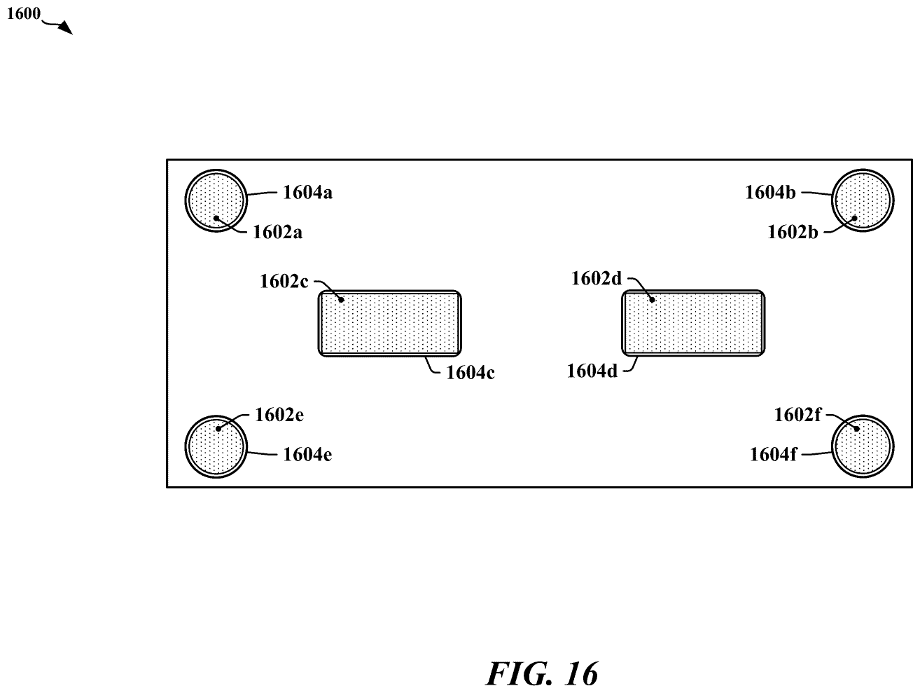

FIG. 16 illustrates an example of a modular charging device layout on a surface 1600 of a table, desk, workbench, countertop, bar top, kitchen worksurface, or other item of furniture in accordance with certain aspects of this disclosure. Modular charging devices may be provided in other items including armrests of an armchair, armrests in an automobile, windowsills in a room, consoles in a vehicle, tray tables in an airplane and other examples. The modular charging devices are deployed to provide multiple charging areas 1602a-160f across the surface 1600 of the table, desk, workbench, countertop, bar top, kitchen worksurface, or other item of furniture. In some examples, at least one of the charging modules may differ from other charging modules in overall size or shape or by the number, size or configuration of included charging coils.

In the illustrated example, each of the charging areas 1602a-1602f is circumscribed by an indicator line 1604a-1604f that follows the shape of the corresponding charging area 1602a-1602f. In some implementations, the indicator lines 1604a-1604f may be formed on the surface of the table, desk, workbench, bar top, kitchen worksurface, or other item of furniture. The term “indicator line” as used herein applies to a straight or curved line that follows at least a portion of the perimeter of a charging area 1602a-1602f. In one example, one or more indicator lines may be provided to encircle, encompass or circumscribe a charging area 1602a-1602f. In some instances, an indicator line may fully enclose a shape such as a circle, oval square rectangle or other regular or irregular shape. In some instances, an indicator line may be partially illuminated such that some points, dots or sections of the indicator line are illuminated and other points, dots or sections of the indicator line are not illuminated. Indicator lines are depicted in the drawings using a solid, dotted or dashed line regardless of whether the corresponding indicator line can be illuminated along the entirety of its length or illuminated at certain points, dots or sections of the indicator line.

In certain implementations, the indicator lines 1604a-1604f may be obtained by projecting light onto a lower surface of the table, desk, workbench, bar top, kitchen worksurface, or other item of furniture such that some portion of the light penetrates the surface. In some implementations, a countertop may be fabricated from stone, ceramic or other material that is translucent or capable of conducting light. The light may produce illuminated shapes such as lines, dots, or some combination of lines and dots on the countertop to indicate one or more active charging areas. In one example light generated by LED lamps or strips may penetrate 2 centimeters (2 cm) or more through a stone countertop. In other examples, the density of the stone may significantly limit the light conducted from a lower surface to the upper surface such that the thickness of the countertop proximate to the indicator lines 1604a-1604f is less than 2 cm.

It is contemplated that, in some instances, a transparent, semitransparent, translucent or diaphanous material may be inlaid or embedded in an otherwise opaque countertop material to form the indicator lines 1604a-1604f. In some instances, an inlay provided in the otherwise opaque countertop may have light refracting and/or light diffusing properties such that the indicator lines 1604a-1604f may be formed by conducting light through the inlay. In some instances, the inlay may comprise a broken line of holes or channels that are filled with an inlaid or embedded material.

In some implementations, light sources such as LED lamps or strips of LED lamps can be used to illuminate the indicator lines 1604a-1604f. The LED lamps may be configured to emit colored light that is visible to a user during placement and/or charging of a device through the charging surface. In some examples, light from the LED lamps is carried through light pipes, light guides and/or light diffusers to an upper surface of the table, desk, workbench, bar top, kitchen worksurface, or other item of furniture. In some implementations, the light pipes, light guides or light diffusers may be used alone or in combination to provide the visible indicator line 1604a-1604f on the table, desk, workbench, bar top, kitchen worksurface, or other item of furniture. In these latter implementations, the visible indicator line 1604a-1604f may be illuminated when a chargeable device is detected nearby, or may be in an always on state. The visible indicator line 1604a-1604f may present a first color to indicate availability of charging circuits and may present a second color to indicate that the charging surface is in use. In some instances, the color of the visible indicator line 1604a-1604f may indicate whether charging is in progress or completed, or whether an error has occurred. The error may relate to misalignment of the chargeable device, presence of a foreign object, an overheating condition or the like.

Certain aspects of this disclosure relate to charging systems that include a low-cost passive or active wireless tag that can be repeatedly enabled and disabled. In some implementations, the wireless tag can be configured to trigger actions taken by a mobile device that is presented for charging by a wireless charging device and/or placed on a countertop, table or other surface. The wireless tag may be implemented as a low power device that can operate using a small amount of energy harvested from an incident radio frequency (RF) field. The wireless tag may communicate in accordance with Near-field communication (NFC) standards or protocols. In one example, the wireless tag may operate in accordance with a radio-frequency identification (RFID) protocol. The energy used to operate the wireless tag may be extracted from an interrogation signal transmitted by an interrogating device, RFID reader or other device. In one aspect of this disclosure, the mobile device may be configured to operate as an interrogating device. Certain devices constructed according to certain aspects of the presently described invention can be incorporated in, or controlled by wireless charging devices.

According to certain aspects of this disclosure, a wireless tag may communicate in an RF band at or near 900 MHz (UHF) and/or in accordance with industry standard air interface protocols, including ISO-13092 at UHF frequencies, FeliCa, ISO-14443, the Global System for Mobile Communications Association (GSMA) NFC standards, and various standards and protocols defined by the NFC Forum. The ISO-14443 standard is defined by a technical committee of the International Organization for Standardization (ISO) and the International Electrotechnical Commission (IEC) and may be used for contactless transaction including transactions involving credit cards, for example. Other standards, protocols and frequencies may be used in a wireless tag, including ZigBee, Bluetooth, IEEE 802.11x and other proprietary protocols.

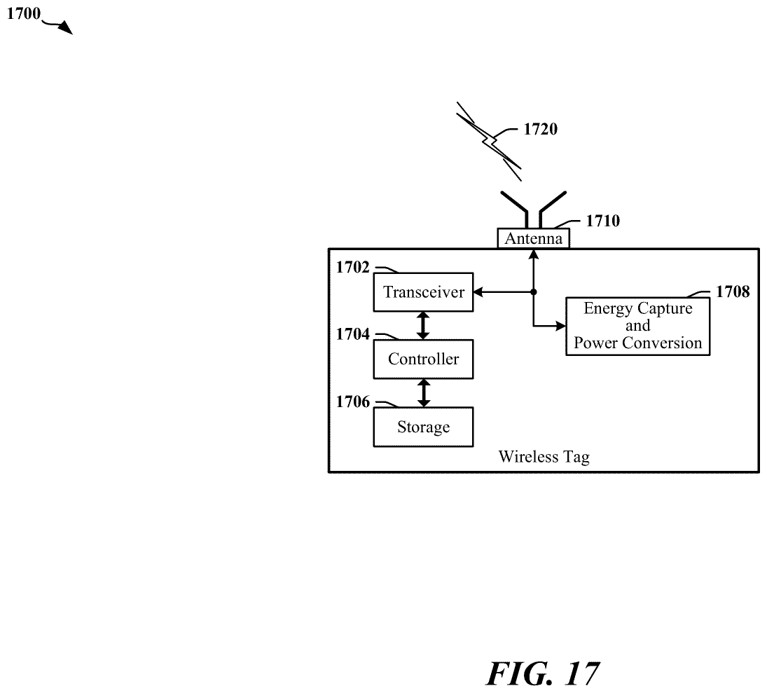

FIG. 17 illustrates an example of a wireless tag 1700 that may be adapted in accordance with certain aspects of this disclosure. The wireless tag 1700 may be implemented in single IC device that comprises a low-power transceiver 1702, a controller 1704 and storage 1706. The low-power transceiver 1702 may be configured for transmitting and receiving wireless communication using an antenna 1710. The antenna 1710 may be provided external to the IC device. The antenna 1710 may be disposed upon or attached to the IC device, fabricated in the IC device, painted on the IC device or located apart from, or proximately to the IC device. In some implementations, the antenna 1710 may be formed as a loop antenna or a dipole antenna. The wireless communication may facilitate an exchange of information, typically according to a standards-based transmission protocol that may specify formats for transmitting the information. The information may include command and data elements and the protocol may specify sequences for exchange of passwords, encryption keys and other identifying information.

Certain identifying information, encryption keys, unique identifiers and preformed message payloads may be loaded into the storage 1706 during manufacturing, initialization or application-controlled configuration of the wireless tag 1700. In one example, unique identifiers, passwords and/or encryption keys can be used to authenticate wireless communication. In some implementations, wireless communication may be unauthenticated and unencrypted, and information exchanged through wireless communication may identify one or more specific actions to be taken by the wireless controller 1704, and/or to select a preformed message payload to be transmitted by the wireless tag 1700 in response to interrogation through a received wireless signal 1720.

The wireless tag 1700 may comprise energy capture and power conversion circuits 1708. In some implementations, the energy capture and power conversion circuits 1708 may be wholly provided within the IC device that includes the low-power transceiver 1702, controller 1704 and storage 1706. In some implementations, a portion of the energy capture and power conversion circuits 1708 is provided within the IC device that includes the low-power transceiver 1702, controller 1704 and storage 1706, with certain components such as large capacitors being located externally. In some implementations, substantially all of the energy capture and power conversion circuits 1708 is provided externally. In some implementations, the wireless tag 1700 may be powered by an external power source or battery.

The energy capture and power conversion circuits 1708 may include an energy harvesting circuit configured to divert some portion of a current induced in the antenna 1710 by the received wireless signal 1720. The energy capture and power conversion circuits 1708 may rectify the received wireless signal 1720 and may provide a direct current (DC) to an energy storage circuit. In some instances, the energy storage circuit comprises one or more capacitors. In some implementations, the energy capture and power conversion circuits 1708 comprises power conversion circuits that include one or more DC-DC converters. In some implementations, a buck-boost converter circuit may be used to selectively increase or decrease the magnitude of the voltage of a power output of the energy capture and power conversion circuits 1708. In some implementations, a high-efficiency charge pump circuit may be used to selectively increase or decrease the magnitude of the voltage of the power output of the energy capture and power conversion circuits 1708.

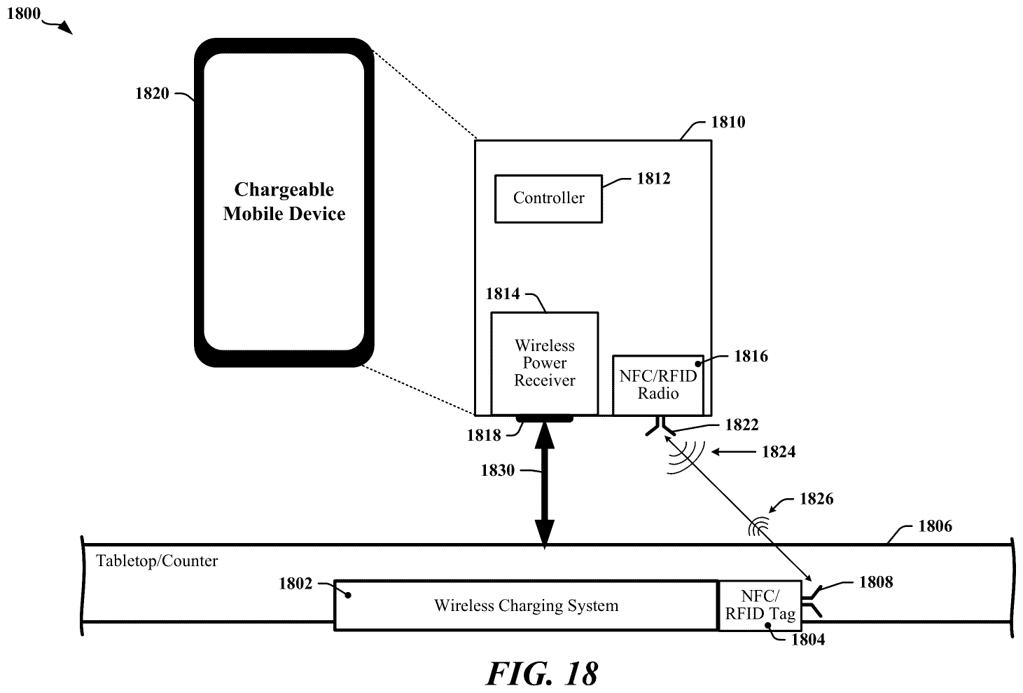

FIG. 18 illustrates an example of a charging system 1800 in which a wireless charging circuit 1802 and one or more wireless tags 1804 may be provided within and/or attached to a tabletop, counter or other work surface 1806. A mobile device 1820 can be configured to interrogate the wireless tag 1804 when the mobile device 1820 is placed on the tabletop, counter or other work surface 1806 or near the wireless charging circuit 1802. The mobile device 1820 has a processing circuit 1810 that includes a controller 1812 or other processor and that further includes, or is coupled to a wireless power receiver 1814 and an RFID/NFC radio 1816. The mobile device 1820 may be a cellular telephone, a smartphone, a multimedia device, a video device, a digital audio player (e.g., MP3 player), a camera, an entertainment device, a wearable computing device (e.g., a smart watch, a health or fitness tracker, eyewear, etc.), an appliance, a sensor, a security device, a drone, a multicopter, or any other similar functioning device.

The wireless power receiver 1814 includes, or is coupled to a receiving coil 1818 that is configured to generate a charging current in response to electromagnetic flux 1830 received from the wireless charging circuit 1802. The receiving coil 1818 functions as an antenna that is tuned to the frequency of the electromagnetic flux 1830. The RFID/NFC radio 1816 may be configured to transmit and receive signals 1824, 1826 through an NFC/RFID radio antenna 1822 at frequencies defined by RFID, NFC or other standards and protocols. In some implementations, the receiving coil 1818 can perform the functions of the NFC/RFID radio antenna 1822. The wireless tag 1804 typically includes an antenna 1808 and may operate as a passive or active wireless tag.

In certain implementations, the wireless tag 1804 responds to an interrogating signal 1824 by transmitting a predefined message in a response signal 1826. In one example, the predefined message may cause the mobile device 1820 to display information pertinent or to the environment context or usage of the tabletop, counter or other work surface 1806. In one example, the information may be displayed through an application installed on the mobile device 1820. In another example, the information may be accessed through a website indicated by the predefined message transmitted in the response signal 1826. In some instances, the information displayed in response to the wireless tag 1804 may include or be related to instructions or troubleshooting for a recently installed appliance. In some instances, the information displayed in response to the wireless tag 1804 may include timely reminders or content. In some instances, the information displayed in response to the wireless tag 1804 may include advertisements.

In some implementations, the wireless tag 1804 can be configured to advertise websites and other services. When the mobile device 1820 is moved close to a preprogrammed wireless tag 1804, a pop-up notification is provided on the display of the mobile device 1820 suggesting a visit to the website advertised by the wireless tag 1804.

In general, the information provided using a wireless tag 1804 may become stale or redundant. Even if a targeted website is modified on occasion, a user of the mobile device may wish to block the notifications. In some implementations, the wireless tag 1804 may be used in a restaurant to cause the mobile device 1820 to automatically display a menu. This feature may be provided as a subscription service and, in some instances, the service provider may wish to block access to the website hosting the menu. For example, the subscription may be unpaid or lapsed and the server provider may wish to rapidly terminate providing automatic access to the website. Disablement of conventional wireless tags is typically permanent and involves destroying connections within the wireless tag.

Wireless tags 1804 configured or adapted in accordance with certain aspects of this disclosure are provided with an on/off switch facility that enables the wireless tag 1804 to be repeatedly enabled and disabled without damaging the wireless tag 1804. In certain implementations, the on/off switch facility enables the antenna to be shorted or disconnected when the switch is turned off.

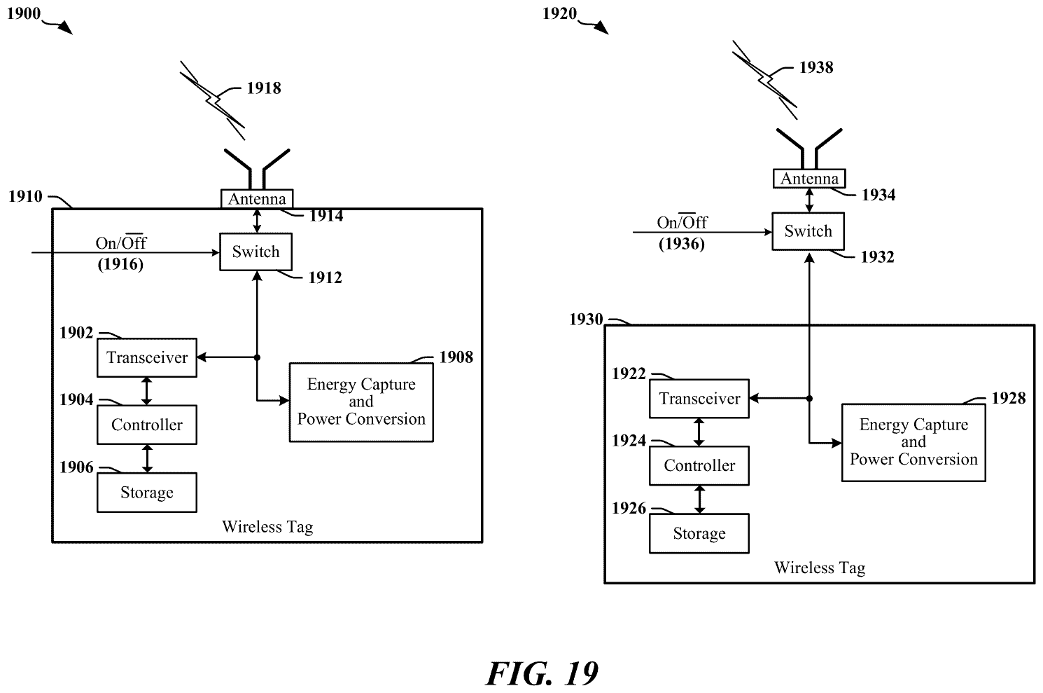

FIG. 19 illustrates examples of wireless tags 1900, 1920 that can be repetitively enabled and disabled in accordance with certain aspects of this disclosure. The first illustrated wireless tag 1900 may be implemented in a single IC device that comprises a low-power transceiver 1902, a controller 1904 and storage 1906. An antenna 1914 is coupled to the low-power transceiver 1902 and energy capture and power conversion circuits 1908 through a switching circuit 1912 that is controlled using a control signal 1916. The control signal 1916 may be provided internally by the controller 1904 or by an external controller. The antenna 1914 may be provided external to the IC device. The low-power transceiver 1902 may be configured for transmitting and receiving wireless communication using the antenna 1914, which may be disposed on the IC device, fabricated on the IC device, painted on the IC device or located apart from, or proximately to the IC device. In some implementations, the antenna 1914 may be formed as a loop antenna or a dipole antenna. The wireless communication may facilitate an exchange of information, typically according to a standards-based transmission protocol that may specify formats for transmitting the information. The information may include command and data elements and the protocol may specify sequences for exchange of passwords, encryption keys and other identifying information.

The second illustrated wireless tag 1920 includes an IC device 1930 that comprises a low-power transceiver 1922, a controller 1924 and storage 1906. An external antenna 1934 is coupled to the low-power transceiver 1922 and energy capture and power conversion circuits 1928 in the IC device 1930 through a switching circuit 1932 that is controlled using a control signal 1936. In this example, the control signal 1936 is typically provided by an external controller. The low-power transceiver 1922 may be configured for transmitting and receiving wireless communication using the antenna 1934. The antenna 1934 may be coupled to the IC device 1930 through wires or interconnects. The switching circuit 1932 may be added by interrupting one or more wires or connectors that are provided to couple the antenna 1934 to the IC device 1930. One or more transistors, one or more optically-activated switches and/or one or electromagnetically activated switches may be used to couple the antenna 1934 and the IC device 1930. The antenna 1934 can be selectively reconnected to the IC device 1930 based on the signaling state of the control signal 1936. The antenna 1934 may be deposited or painted on an external surface of the IC device 1930, or may be located apart from, or proximately to the IC device 1930. In some implementations, the antenna 1934 may be formed as a loop antenna or a dipole antenna.

The wireless tags 1900, 1920 may be configured to support wireless communication that facilitates an exchange of information, typically according to a standards-based transmission protocol that may specify formats for transmitting the information. The information may include command and data elements and the protocol may specify sequences for exchange of passwords, encryption keys and other identifying information.

Certain identifying information, encryption keys, unique identifiers and preformed message payloads may be loaded into the storage 1906, 1926 during manufacturing, initialization or application-controlled configuration of the corresponding wireless tag 1900, 1920. Unique identifiers, passwords and/or encryption keys may be used to authenticate wireless communication. In some implementations, wireless communication may be unauthenticated and unencrypted. Information exchanged through wireless communication may identify one or more specific actions to be taken by the respective wireless controllers 1904, 1924. Information exchanged through wireless communication may be configured to select a preformed message payload to be transmitted by the corresponding wireless tag 1900, 1920 in response to interrogation through a received wireless signal 1918 or 1938.

The wireless tags 1900, 1920 may comprise energy capture and power conversion circuits 1908, 1928. In some implementations, the energy capture and power conversion circuits 1908, 1928 may be collocated on the same semiconductor die with the corresponding low-power transceiver 1902, 1922, controller 1904, 1924 and storage 1906, 1926. In some implementations, portions of the energy capture and power conversion circuits 1908, 1928 are provided within the IC device 1910 or 1930 that includes the corresponding low-power transceiver 1902, 1922, controller 1904, 1924 and storage 1906, 1926 with certain components such as large capacitors being located externally. In some implementations, substantially all of the energy capture and power conversion circuits 1908, 1928 are provided externally. In some implementations, the wireless tag 1900 or 1920 may be powered by an external power source or battery (not shown).

The energy capture and power conversion circuits 1908, 1928 may include an energy harvesting circuit configured to divert some portion of a current induced in the antenna 1914, 1934 by the received wireless signal 1918, 1938. The energy capture and power conversion circuits 1908, 1928 may rectify the energy in the received wireless signal 1918, 1938 and may provide DC power to an energy storage circuit. The energy storage circuit may include one or more capacitors, for example. In some implementations, the energy capture and power conversion circuits 1908, 1938 include one or more DC-DC converters. In some implementations, a buck-boost converter circuit may be used to selectively increase or decrease the magnitude of the voltage of a power output of the energy capture and power conversion circuits 1908 or 1928. In some implementations, a high-efficiency charge pump circuit may be used to selectively increase or decrease the magnitude of the voltage of the power output of the energy capture and power conversion circuits 1908, 1928.

The switching circuit 1912 in the first illustrated wireless tag 1900 may be used to disconnect the low-power transceiver 1902, controller 1904 and/or storage 1906 from an internal or external power supply. In some instances, the power supply is sourced by the energy capture and power conversion circuits 1908. Disruption of the power supply can prevent the detection of a stimulation signal received from an RFID/NFC radio 1816 (see FIG. 18) by one or more components of the first illustrated wireless tag 1900. Disruption of the power supply can prevent transmission of a response to a stimulation signal received from an RFID/NFC radio 1816.

The switching circuit 1932 in the second illustrated wireless tag 1920 may be used to disconnect the IC device 1930 from an external power supply. Disruption of the power supply can prevent the detection of a stimulation signal received from an RFID/NFC radio 1816 by one or more components of the second illustrated wireless tag 1920. Disruption of the power supply can prevent transmission of a response to a stimulation signal received from an RFID/NFC radio 1816. In some implementations, the IC device 1930 can be disabled by an externally supplied enable signal. In such implementations, the switching circuit 1932 may be configured to provide the enable signal.

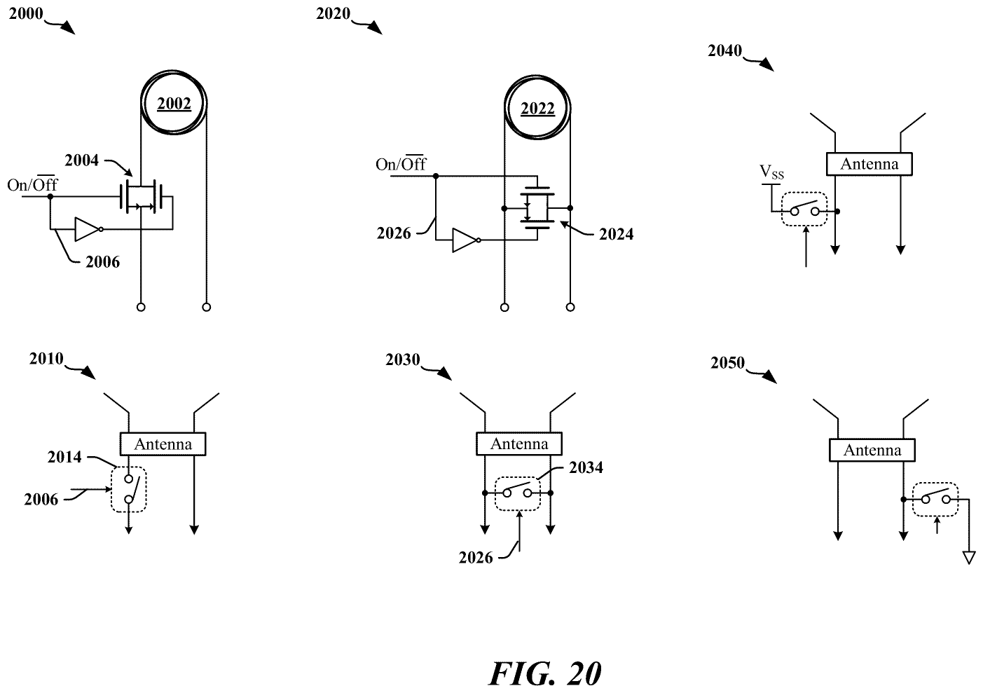

FIG. 20 illustrates certain examples of circuits that may be used to implement the switching circuits 1912, 1932 (see FIG. 19). A first circuit example 2000, represented by the related schematic 2010, includes a switch 2014 that is coupled to one terminal of an antenna (here, the loop antenna 2002) to permit controlled disruption or interruption of the circuit that includes the antenna. The switch 2014 can be controlled and operated to disable the antenna by disrupting the antenna circuit. The switch 2014 is implemented in this example using a pass gate circuit 2004 controlled by an On/Off signal 2006. The On/Off signal 2006 may be provided by a controller of the second illustrated wireless tag 1920, or a controller of a collocated charging device or charging module. The On/Off signal 2006 may be carried over a wire, a wireless connection, or may be derived using an optical receiver that includes a photodiode or phototransistor. In the latter example, the photodiode or phototransistor may be excited by an LED lamp controlled by the controller of the second illustrated wireless tag 1920, or the controller of the collocated charging device or another charging module. More than one switch 2014 may be provided such that each terminal of an antenna can be disconnected to facilitate controlled disruption or interruption of the circuit that includes the antenna.

A second circuit example 2020, represented by the related schematic 2030, includes a switch 2034 that is coupled to both terminals of an antenna (here, the loop antenna 2022). The switch 2034 can be controlled and operated to disable the antenna by short-circuiting the terminals of the antenna. The switch 2034 is implemented in this example using a pass gate circuit 2024 controlled by an On/Off signal 2026. The On/Off signal 2026 may be provided by a controller of the second illustrated wireless tag 1920, or a controller of a collocated charging device. The On/Off signal 2026 may be carried over a wire, a wireless connection, or may be derived using an optical receiver that includes a photodiode or phototransistor. In the latter example, the photodiode or phototransistor may be excited by an LED lamp controlled by the controller of the second illustrated wireless tag 1920, or the controller of the collocated charging device or another charging module.

In a third example (schematic 2040), the antenna may be disabled by short-circuiting one or more terminals of the antenna to a power rail. In a fourth example (schematic 2050), the antenna may be disabled by short-circuiting one or more terminals of the antenna to a ground rail. In some implementations, both terminals can be short-circuited to the same rail.

The switch used in these examples may be implemented using any suitable controllable switching technology, including electromechanical relays a MOSFET, or a contactless switch using light, electromagnetic, magnetic, RF or other activation. In some implementations, the switch may be one of a plurality of switches used to enable or disable a wireless tag, and the switches may be implemented using addressable activation signals, whether wired or wireless. Accordingly, one or more wireless tags may be enabled or disabled in response to a command or event.

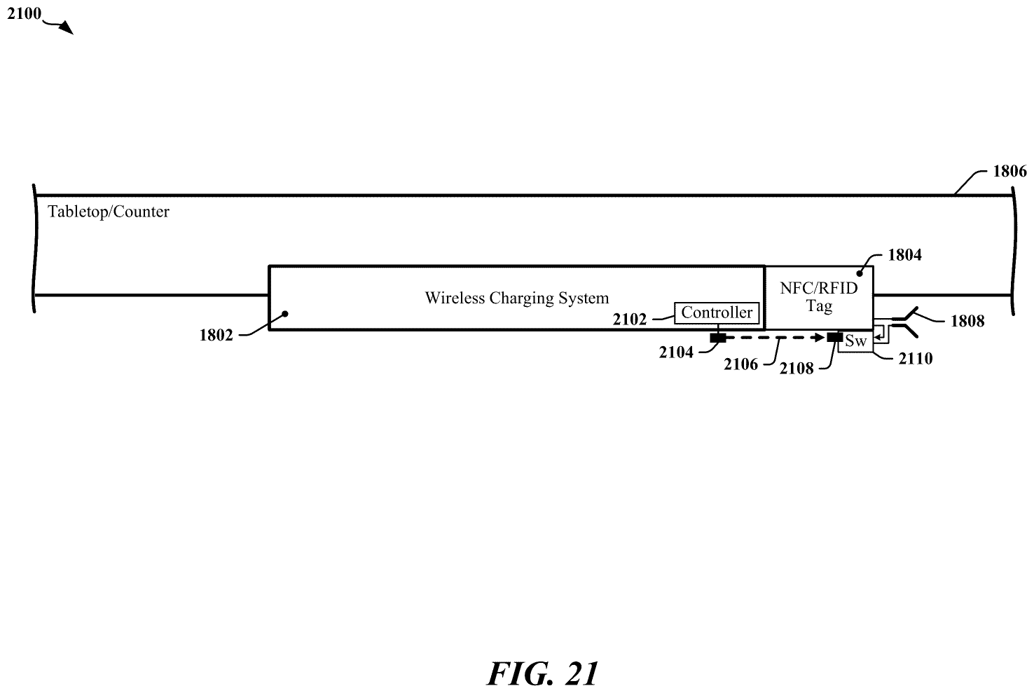

FIG. 21 illustrates an example of a switching circuit 2110 that is activated through an optical signaling path in accordance with certain aspects disclosed herein. The switching circuit may be added to a charging system 2100. The charging system 2100 may correspond to the charging system 1800 illustrated in FIG. 18. An optical transmitter 2104 may be attached to or positioned near the wireless charging circuit 1802 and may be coupled to a controller 2102 or processing circuit in the wireless charging circuit 1802. In some instances, the optical transmitter 2104 may be coupled to an external controller (not shown). In one example, an input of the optical transmitter 2104 receives a control signal from the controller 2102 or processing circuit in the wireless charging circuit 1802 or from the external controller. The optical transmitter 2104 may be configured to emit light 2106 when the control signal is in a first signaling state and to refrain from emitting light 2106 when the control signal is in a second signaling state. The optical transmitter 2104 may include or use an LED to emit light 2106. In some implementations, the LED may be configured to emit laser light. In some implementations, the LED may be configured to emit infrared light.

A light sensitive receiver 2108 may be configured to detect the presence or absence of light received from the optical transmitter 2104. The light sensitive receiver 2108 may be configured further to generate an On/Off signal 2006, 2026 (see FIG. 20) that can be used to control the switching circuit 2110. In some instances, the light sensitive receiver 2108 may be implemented in the switching circuit 2110 and the switching circuit 2110 may be configured or arranged to detect the light 2106 emitted by the optical transmitter 2104. In some implementations, the light sensitive receiver 2108 includes a photodiode. In some implementations, the light sensitive receiver 2108 includes a phototransistor. In some implementations, the switching circuit 2110 is configured to disable the antenna 1808 when no light 2106 emitted by the optical transmitter 2104 is detected and to enable the antenna 1808 when light 2106 emitted by the optical transmitter 2104 is detected. In other implementations, the switching circuit 2110 is configured to enable the antenna 1808 when no light 2106 emitted by the optical transmitter 2104 is detected and to disable the antenna 1808 when light 2106 emitted by the optical transmitter 2104 is detected.

The use of optical signaling as illustrated in FIG. 21 enables the switching circuit 2110 to be controlled by the controller 2102 or processing circuit in the wireless charging circuit 1802 without substantial rework of the charging system 1800. In many implementations, unused general-purpose input/output (GPIO) pins are available and exposed on a processing circuit or integrated circuit. An unused GPIO pin may be accessible for connection to the optical transmitter 2104 and the signaling state of the unused GPIO pin can be controlled by reprogramming the controller 2102 or processing circuit in the wireless charging circuit 1802.

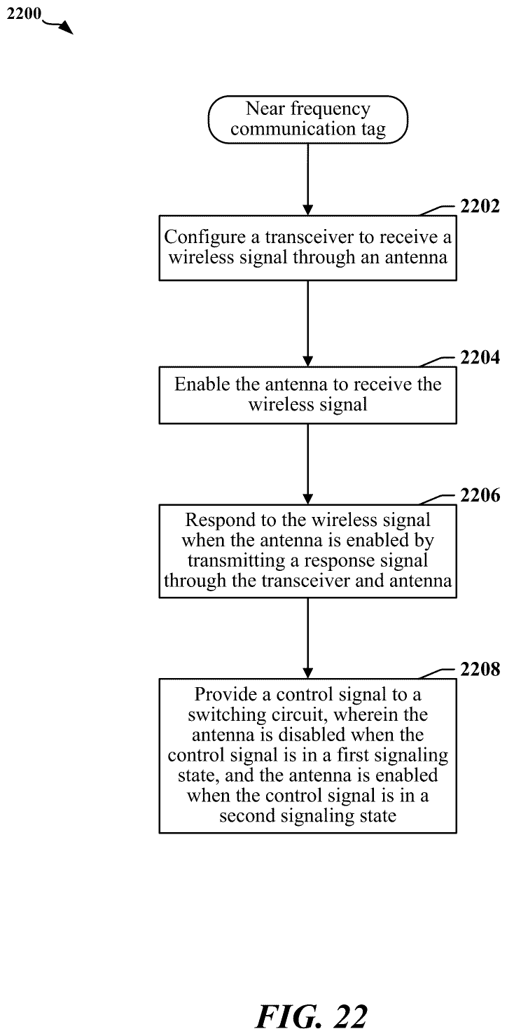

FIG. 22 is flowchart 2200 illustrating one example of a method for operating a wireless tag. The wireless tag may correspond in some respects to the wireless tag 1900 illustrated in in FIG. 19. In some examples, the wireless tag is configured as an RFID tag. In some examples, the wireless tag is configured to use NFC wireless communication protocols. The wireless tag may be configured to operate according to proprietary or other wireless communication protocols.

At block 2202, a transceiver is configured to receive a wireless signal through an antenna. At block 2204, the antenna is enabled to receive the wireless signal. The antenna may be enabled using a switching circuit that couples the transceiver to the antenna, for example. At block 2206, a response signal may be transmitted through the transceiver and antenna in response to the wireless signal. In some examples, the response signal is encoded with a preconfigured or predefined message. In some instances, the preconfigured or predefined message includes a universal resource locator (URL) that identifies a site on the world wide web or a page in a social media systems. At block 2208, a control signal is provided to a switching circuit. The antenna may be disabled when the control signal is in a first signaling state. The antenna may be enabled when the control signal is in a second signaling state.

In some implementations, the control signal is provided by a controller associated with the wireless tag. In various implementations, the control signal is received from an external controller. In certain implementations, the near frequency communication tag is collocated with a wireless charging device. The control signal may be provided by a processing circuit of the wireless charging device. In some instances, the wireless charging device is embedded in a countertop or tabletop or otherwise attached to a countertop or tabletop. In some implementations, signaling state of the control signal is determined by an optical receiver and based on detection or non-detection of light transmitted by a light source coupled to an external processing circuit or controller. The optical receiver may include a photodiode or a phototransistor. The light source may include an infrared LED. The light source may produce laser light. The light source may be communicatively coupled to a wireless charging device.

In some implementations, the method includes extracting energy from the signal received at the antenna and further configured to store the energy to be used when transmitting the response signal.

### Example of a Processing Circuit

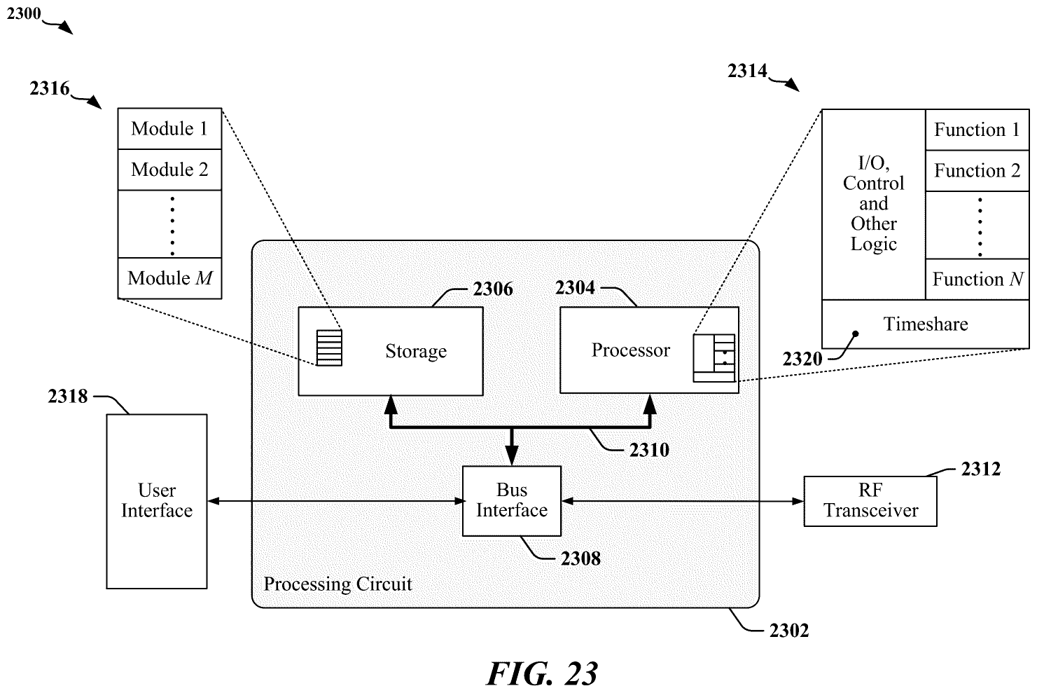

FIG. 23 is a diagram illustrating an example of a hardware implementation for an apparatus 2300 that may be incorporated in a charging device or in a receiving device that enables a battery to be wirelessly charged. In some examples, the apparatus 2300 may perform one or more functions disclosed herein. In accordance with various aspects of the disclosure, an element, or any portion of an element, or any combination of elements as disclosed herein may be implemented using a processing circuit 2302. The processing circuit 2302 may include one or more processors 2304 that are controlled by some combination of hardware and software modules. Examples of processors 2304 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2304 may include specialized processors that perform specific functions, and that may be configured, augmented or controlled by one of the software modules 2316. The one or more processors 2304 may be configured through a combination of software modules 2316 loaded during initialization, and further configured by loading or unloading one or more software modules 2316 during operation.

In the illustrated example, the processing circuit 2302 may be implemented with a bus architecture, represented generally by the bus 2310. The bus 2310 may include any number of interconnecting buses and bridges depending on the specific application of the processing circuit 2302 and the overall design constraints. The bus 2310 links together various circuits including the one or more processors 2304, and storage 2306. Storage 2306 may include memory devices and mass storage devices, and may be referred to herein as computer-readable media and/or processor-readable media. The storage 2306 may include transitory storage media and/or non-transitory storage media.

The bus 2310 may also link various other circuits such as timing sources, timers, peripherals, voltage regulators, and power management circuits. A bus interface 2308 may provide an interface between the bus 2310 and one or more transceivers 2312. In one example, a transceiver 2312 may be provided to enable the apparatus 2300 to communicate with a charging or receiving device in accordance with a standards-defined protocol. Depending upon the nature of the apparatus 2300, a user interface 2318 (e.g., keypad, display, speaker, microphone, joystick) may also be provided, and may be communicatively coupled to the bus 2310 directly or through the bus interface 2308.

A processor 2304 may be responsible for managing the bus 2310 and for general processing that may include the execution of software stored in a computer-readable medium that may include the storage 2306. In this respect, the processing circuit 2302, including the processor 2304, may be used to implement any of the methods, functions and techniques disclosed herein. The storage 2306 may be used for storing data that is manipulated by the processor 2304 when executing software, and the software may be configured to implement any one of the methods disclosed herein, including the method illustrated by the flowchart in FIG. 22.

One or more processors 2304 in the processing circuit 2302 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2306 or in an external computer-readable medium. The external computer-readable medium and/or storage 2306 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2306 may also include, by way of example, a carrier wave, a transmission line, and any other suitable medium for transmitting software and/or instructions that may be accessed and read by a computer. Computer-readable medium and/or the storage 2306 may reside in the processing circuit 2302, in the processor 2304, external to the processing circuit 2302, or be distributed across multiple entities including the processing circuit 2302. The computer-readable medium and/or storage 2306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2306 may maintain software maintained and/or organized in loadable code segments, modules, applications, programs, etc., which may be referred to herein as software modules 2316. Each of the software modules 2316 may include instructions and data that, when installed or loaded on the processing circuit 2302 and executed by the one or more processors 2304, contribute to a run-time image 2314 that controls the operation of the one or more processors 2304. When executed, certain instructions may cause the processing circuit 2302 to perform functions in accordance with certain methods, algorithms and processes described herein.

Some of the software modules 2316 may be loaded during initialization of the processing circuit 2302, and these software modules 2316 may configure the processing circuit 2302 to enable performance of the various functions disclosed herein. For example, some software modules 2316 may configure internal devices and/or logic circuits 2324 of the processor 2304, and may manage access to external devices such as a transceiver 2312, the bus interface 2308, the user interface 2318, timers, mathematical coprocessors, and so on. The software modules 2316 may include a control program and/or an operating system that interacts with interrupt handlers and device drivers, and that controls access to various resources provided by the processing circuit 2302. The resources may include memory, processing time, access to a transceiver 2312, the user interface 2318, and so on.

One or more processors 2304 of the processing circuit 2302 may be multifunctional, whereby some of the software modules 2316 are loaded and configured to perform different functions or different instances of the same function. The one or more processors 2304 may additionally be adapted to manage background tasks initiated in response to inputs from the user interface 2318, the transceiver 2312, and device drivers, for example. To support the performance of multiple functions, the one or more processors 2304 may be configured to provide a multitasking environment, whereby each of a plurality of functions is implemented as a set of tasks serviced by the one or more processors 2304 as needed or desired. In one example, the multitasking environment may be implemented using a timesharing program 2320 that passes control of a processor 2304 between different tasks, whereby each task returns control of the one or more processors 2304 to the timesharing program 2320 upon completion of any outstanding operations and/or in response to an input such as an interrupt. When a task has control of the one or more processors 2304, the processing circuit is effectively specialized for the purposes addressed by the function associated with the controlling task. The timesharing program 2320 may include an operating system, a main loop that transfers control on a round-robin basis, a function that allocates control of the one or more processors 2304 in accordance with a prioritization of the functions, and/or an interrupt driven main loop that responds to external events by providing control of the one or more processors 2304 to a handling function.

In some examples, the apparatus 2300 is included in, or operates as a wireless charging system that has a battery charging power source coupled to a charging circuit, a plurality of charging cells and one or more processors 2304. The plurality of charging cells may be configured to provide one or more charging surfaces that may be physically separated. At least one coil may be configured to direct an electromagnetic field through a charge transfer area of each charging cell. In one example, the charging system includes a plurality of transmitting coils arranged in a pattern therein. The plurality of transmitting coils may include Litz coils and may define a charging surface

In one implementation, a wireless tag has an antenna configured to receive a wireless signal when enabled, a transceiver coupled to an antenna and configured to process the wireless signal, a controller configured to respond to the wireless signal by transmitting a response signal through the transceiver and antenna when the antenna is enabled, and a switching circuit configured to enable and disable the antenna responsive to a control signal. The antenna may be disabled when the control signal is in a first signaling state. The antenna may be enabled when the control signal is in a second signaling state. The transceiver may using amplify, filter and/or equalize the wireless signal.

In some examples, the control signal is provided by the controller. The control signal may be received from an external controller. The wireless tag may be collocated with a wireless charging device. The control signal may be provided by a processing circuit of the wireless charging device. The wireless charging device may be embedded in a countertop or tabletop. The wireless charging device may be attached to a countertop or tabletop.

In some implementations, an optical receiver is configured to define signaling state of the control signal based on detection or non-detection of light transmitted by a light source coupled to an external processing circuit or controller. An energy capture circuit may be configured to extract energy from the signal received at the antenna and further configured to store the energy to be used when transmitting the response signal. In some implementations, the antenna may be disabled when the switching circuit disconnects a power supply from one or more subcircuits of the wireless tag. Disruption of the power supply can prevent transmission of a response to a stimulation signal received from an RFID/NFC radio. In some implementations, the wireless tag can be disabled by an externally supplied enable signal. In such implementations, the switching circuit may be configured to provide the enable signal.

In some implementations, the control signal is provided by a controller associated with the wireless tag. In various implementations, the control signal is received from an external controller. In certain implementations, the near frequency communication tag is collocated with a wireless charging device. The control signal may be provided by a processing circuit of the wireless charging device. In some instances, the wireless charging device is embedded in a countertop or tabletop or otherwise attached to a countertop or tabletop. In some implementations, signaling state of the control signal is determined by an optical receiver and based on detection or non-detection of light transmitted by a light source coupled to an external processing circuit or controller. The optical receiver may include a photodiode or a phototransistor. The light source may include an infrared LED. The light source may produce laser light. The light source may be communicatively coupled to a wireless charging device.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A wireless tag, comprising:
an antenna configured to receive a wireless signal when enabled;
a transceiver coupled to the antenna and configured to process the wireless signal;
a controller configured to respond to the wireless signal by transmitting a response signal through the transceiver and antenna when the antenna is enabled; and
a switching circuit configured to enable and disable the antenna responsive to a control signal, wherein the antenna is disabled when the control signal is in a first signaling state, and the antenna is enabled when the control signal is in a second signaling state.

2. The wireless tag of claim 1, wherein the control signal is provided by the controller.

3. The wireless tag of claim 1, wherein the control signal is received from an external controller.

4. The wireless tag of claim 1, wherein the wireless tag is collocated with a wireless charging device.

5. The wireless tag of claim 4, wherein the control signal is provided by a processing circuit of the wireless charging device.

6. The wireless tag of claim 4, wherein the wireless charging device is embedded in a countertop or tabletop.

7. The wireless tag of claim 4, wherein the wireless charging device is attached to a countertop or tabletop.

8. The wireless tag of claim 1, further comprising:
an optical receiver configured to define signaling state of the control signal based on detection or non-detection of light transmitted from a light source coupled to an external processing circuit or controller.

9. The wireless tag of claim 1, further comprising:
an energy capture circuit configured to extract energy from the wireless signal received at the antenna and further configured to store the energy to be used when transmitting the response signal.

10. A method for operating a wireless tag, comprising:
configuring a transceiver to receive a wireless signal through an antenna;
enabling the antenna to receive the wireless signal;
responding to the wireless signal when the antenna is enabled by transmitting a response signal through the transceiver and antenna; and
providing a control signal to a switching circuit,
wherein the antenna is disabled when the control signal is in a first signaling state, and the antenna is enabled when the control signal is in a second signaling state.

11. The method of claim 10, wherein the control signal is provided by a controller associated with the wireless tag.

12. The method of claim 10, wherein the control signal is received from an external controller.

13. The method of claim 10, wherein the wireless tag is collocated with a wireless charging device.

14. The method of claim 13, wherein the control signal is provided by a processing circuit of the wireless charging device.

15. The method of claim 13, wherein the wireless charging device is embedded in a countertop or tabletop.

16. The method of claim 13, wherein the wireless charging device is attached to a countertop or tabletop.

17. The method of claim 10, wherein signaling state of the control signal is determined by an optical receiver and based on detection or non-detection of light transmitted from a light source coupled to an external processing circuit or controller.

18. The method of claim 10, further comprising:
extracting energy from the wireless signal received at the antenna and further configured to store the energy to be used when transmitting the response signal.

19. A processor-readable storage medium having instructions stored thereon which, when executed by a controller, cause the controller to:
configure a transceiver to receive a wireless signal through an antenna;
enable the antenna to receive the wireless signal;
respond to the wireless signal when the antenna is enabled by transmitting a response signal through the transceiver and antenna; and
provide a control signal to a switching circuit,
wherein the antenna is disabled when the control signal is in a first signaling state, and the antenna is enabled when the control signal is in a second signaling state.

20. The processor-readable storage medium of claim 19, wherein the antenna is implemented in a wireless tag is collocated with a wireless charging device, the wireless charging device being embedded in a countertop or tabletop, and wherein the control signal is received from a processing circuit of the wireless charging device.
